(19) United States
(12) Patent Application Publication
(10) Pub. No.: US 2025/0023926 A1
(43) Pub. Date: Jan. 16, 2025

(54) Graphical User Interfaces, Systems, and Methods for Content Management and Discovery

(71) Applicant: Shawn Joseph, Austin, TX (US)

(72) Inventor: Shawn Joseph, Austin, TX (US)

(21) Appl. No.: 18/900,877

(22) Filed: Sep. 29, 2024

Related U.S. Application Data
(63) Continuation-in-part of application No. 18/171,009, filed on Feb. 17, 2023.
(60) Provisional application No. 63/587,078, filed on Sep. 30, 2023.
(60) Provisional application No. 63/618,044, filed on Jan. 5, 2024.
(60) Provisional application No. 63/636,406, filed on Apr. 19, 2024.

(51) Int. Cl. H04L 65/1089; H04L 65/1093

(52) U.S. Cl. CPC H04L 65/1089; H04L 65/1093

(57) ABSTRACT

Systems, methods, client devices, and non-transitory computer-readable media are disclosed for displaying one or more graphical user interfaces (GUIs) that facilitate efficient content discovery and/or content interaction. In some embodiments, the GUIs can be used to display a list of items matching one or more queries to allow efficient discovery or relevant items.

### CROSS REFERENCE TO RELATED APPLICATIONS

This application is a Continuation-in-Part of application Ser. No. 18/171,009, filed on Feb. 17, 2023.

This application claims priority from each of U.S. Provisional Application Ser. No. 63/587,078, filed on Sep. 30, 2023, U.S. Provisional Application Ser. No. 63/618,044 filed on Jan. 5, 2024, and U.S. Provisional Application Ser. No. 63/636,406, filed on Apr. 19, 2024.

The disclosures of the foregoing applications are incorporated herein by reference.

### TECHNICAL FIELD

This invention relates generally to graphical user interfaces (GUIs), systems, methods, devices, media, computer-readable instructions, and computer program products for content management and/or discovery.

### SUMMARY

Embodiments herein include one or more graphical user interfaces (GUIs), systems, methods, devices, media, computer-readable instructions, and computer program products for content management, discovery, and/or hyperlocal content discovery.

In accordance with one or more embodiments, a computer implemented method may include using one or more graphical user interfaces (GUIs), cloud, and/or backend systems. In some embodiments, various determinations are made by one or more software service providers that may be carried out in whole, or in part, at any of a server-side, proxy or middleware, cloud, and/or client-side system.

In some embodiments, a system comprising one or more storage devices comprising one or more databases, data stores, memory components, computer readable media, and/or non-transitory computer readable media, and one or more processors in communication with the one or more storage devices is disclosed, wherein the system is configured for storing first group data in the one or more storage devices, the first group data comprising a first group name, and/or a first unique group identifier, and allowing a first user to join the first group.

In some embodiments, a method comprising storing first group data in the one or more storage devices, the first group data comprising a first group name, and/or a first unique group identifier, and allowing a first user to join the first group is disclosed.

In some embodiments, a computer program product comprising a computer readable storage medium having instructions encoded thereon that, when executed by a processor, cause the processor to store first group data in the one or more storage devices, the first group data comprising a first group name, and/or a first unique group identifier, and allow a first user to join the first group, is disclosed.

Other embodiments of this aspect include corresponding computer systems, apparatus, and computer programs recorded on one or more computer storage devices, each configured to perform one or more of the actions of the methods or systems above.

The details of one or more embodiments of the subject matter of this specification are set forth in the accompanying drawings and the description below. Other features, aspects, and advantages of the subject matter will become apparent from the description, the drawings, and the claims.

The subject matter described in this specification can be implemented in particular embodiments so as to realize one or more of the following advantages. Some examples of the advantages of the presented technology include new capabilities, speed, accessibility, discoverability, privacy, efficiency, and/or security over present systems. In one example, by carrying out given security protocols by a software service provider in the presented technology, modifications to the protocols to adapt to emerging needs can be rapidly implemented and deployed. In another example, the presented technology allows for content and/or hyperlocal content discovery.

### BRIEF DESCRIPTION OF THE DRAWINGS

FIG. 1A is a diagram showing a network system 100 according to some embodiments.

FIG. 1B is a diagram showing a network system 101 according to some embodiments.

FIG. 2 is a flowchart showing a general data and/or content discovery process 200 according to some embodiments.

FIG. 3 is a flowchart showing a data and/or content addition process 300 according to some embodiments.

FIG. 4 is a flowchart showing a location data and/or content addition process 400 according to some embodiments.

FIG. 5 is a flowchart showing a local and/or hyperlocal selection process 500 according to some embodiments.

FIG. 6 is a flowchart showing a display process 600 according to some embodiments.

FIG. 7 is a flowchart showing a display process 700 according to some embodiments.

FIG. 8 is a flowchart showing an update process 800 according to some embodiments.

FIG. 9A is a diagram showing a first inclusion/exclusion example 900a according to some embodiments.

FIG. 9B is a diagram showing a second inclusion/exclusion example 900b according to some embodiments.

FIG. 10 is a diagram showing a GUI example 1000, according to some embodiments.

FIG. 11 is a diagram showing a GUI example 1100, according to some embodiments.

FIG. 12 is a diagram showing a GUI example 1200, according to some embodiments.

FIG. 13A is a diagram showing a GUI example 1300, according to some embodiments.

FIG. 13B is a diagram showing a GUI example 1302, according to some embodiments.

FIG. 14 is a diagram showing a GUI example 1400, according to some embodiments.

FIG. 15 is a diagram showing a GUI example 1500, according to some embodiments.

FIG. 16 is a diagram showing a GUI example 1600, according to some embodiments.

FIG. 17 is a diagram showing a GUI example 1700, according to some embodiments.

FIG. 18A is a diagram showing a GUI example 1800, according to some embodiments.

FIG. 18B is a diagram showing a GUI example 1802, according to some embodiments.

FIG. 19 is a diagram showing a GUI example 1900, according to some embodiments.

FIG. 20 is a diagram showing a GUI example 2000, according to some embodiments.

FIG. 21 is a diagram showing a GUI example 2100, according to some embodiments.

FIG. 22 is a diagram showing a GUI example 2200, according to some embodiments.

### DETAILED DESCRIPTION

Hardware and/or software systems including network and/or cloud software systems are becoming more prevalent. Such systems may be used for automation of tasks that are currently inefficient, manual, laborious, and/or impossible. Accordingly, there is a growing need for efficient methods and systems, such as to eliminate more tedious processes or allow for new capabilities previously not possible.

### ACRONYMS

AI/ML—Artificial Intelligence/Machine Learning
AMF—Access & Mobility Management Function
API—Application Programming Interface
AUSF—Authentication Server Function
BSS—Business Support System
CDK—Cloud Development Kit
CI/CD—Continuous Integration and Continuous Delivery
CLI—Command Line Interface
CNF—Cloud-native or Containerized Network Function
CSP—Communication Service Provider
CU—RAN Central Unit
CVE—Common Vulnerabilities and Exposures
DoS—Denial of Service
DR—disaster recovery
DU—RAN Distributed Unit
E2E—end to end
ECR—Elastic Container Registry
EFS—Elastic File System
EKS—Elastic Kubernetes Service
EPC—Evolved Packet Core
HTTP/HTTPS—Hyper Text Transfer Protocol/Hyper Text Transfer Protocol Secure
IaC—Infrastructure as Code
ISV—Independent Software Vendor
MANO—Management and Orchestration
MEC—Multi-Access Edge Computing
NACL—Network Access Control List
NAT—Network Address Translation
NF—Network Function
NFV—Network Function Virtualization
NFVO—Network Function Virtualization Orchestrator
NOC—Network Operations Centre
NRF—Network Repository Function
OSS—Operations Support System
P2P—Peer-to-Peer
PII—Personally Identifiable Information
QoS—Quality of Service
RAN—Radio Access Network
REST—Representational State Transfer
SBI—Service Based Interface
SMF—Session Management Function
SSL—Secure Sockets Layer
TaS—Test as Service
TCP—Transmission Control Protocol
TLS—Transport Layer Security
UDM—Unified Data Management
UDP—User Datagram Protocol
UPF—User Plane Function
VIM—Virtualized Infrastructure Manager
VNF—Virtual Network Function
VPC—Virtual Private Cloud
VPN—Virtual Private Network

### Terminology

### Application Programming Interface

API technologies provide routines, protocols, and tools for building software applications and specifies how software components should interact.

### Cloud Computing

Cloud computing is a model that promotes ubiquitous, on-demand network access to shared computing.

### Public Keys and Private Keys

Public and private keys are created in pairs for each entity involved in a transmission and encrypt and decrypt information during the initial part of the transmission so that only the sender and recipient of the transmission can decrypt and read the information. Public key is available to everyone while the private key is known only to the creator of the keys.

### Software Services

Described in this disclosure are various software services.

A software service may be delivered, or provided by, a third party service, or vendor. The third party service, for example, may be a software service of a vendor. The software service may be hosted at a vendor-owned location, a third party location, or a proxy location, for example.

Software services may utilize any combination of the below components, for example.

### Transport Layer Security/Secure Sockets Layer (TLS/SSL)

Transport Layer Security/Secure Sockets Layer (TLS/SSL) connections make use of public and private keys among parties when establishing a connection and secure almost all transmissions over the internet or computer networks, including emails, web browsing, logins, and financial transactions, ensuring that all data that passes between a web server and a browser remains private and secure.

X.509 certificates

X.509 certificates are digital certificates administered by certificate authorities that use the X.509 PKI standard to verify that a public key belongs to the user, computer, or service identity in the certificate and are used worldwide across public and private sectors.

### X.509 Attribute Certificates

X.509 attribute certificates can encode attributes (such as name, date of birth, address, and unique identifier number), are attached cryptographically to the X.509 certificate, and are administered by attribute certificate authorities.

### Hyper Text Transfer Protocol

It will be understood that the terms HTTP and HTTPS will be used interchangeably and that use of either term includes either alternative.

### Representational State Transfer

Representational state transfer (REST) is a software architectural style that defines a set of constraints to be used for creating Web services. Web services that conform to the REST architectural style, called RESTful Web services, provide interoperability between computer systems on the Internet.

### Virtual Private Networks

One element of a software service may be a Virtual Private Network (VPN). A VPN may establish a secure and private tunnel from a network, terminal, or device, for example to another network element such as a vendor service, for example.

### Security Groups

One element of a software service may be a security group. A security group, rules may be defined that dictate the allowed inbound and/or outbound traffic to a server, for example. For example, a security rule may specify to allow SSH access, from a particular IP address, on a particular port or port range, and using a particular protocol, such as TCP.

### Virtual Private Cloud

One element of a software service may be a Virtual Private Cloud (VPC). A VPC allows isolation of shared cloud resources, for example. In one method, private IP subnets may be assigned to a VPC user that is accompanied by a VPN function or access that secures, by means of authentication and encryption, the user's VPC resources.

### Queues

One element of a software service may be a processing queue. For example, the queue may be processed in a first-in-first-out (FIFO) or last-in-first-out (LIFO) order. The queue may collect several processes to be carried out.

### Server Architecture

A software service may be hosted on elastic server architecture, in one example. In an elastic architecture, computing resources may be automatically increased or decreased to meet computing needs. Computing thresholds may be preset or configured. When a threshold is exceeded for example, additional computing resources may be allocated.

### Serverless Architecture

In another example, a software service may be hosted using serverless architecture. In a serverless architecture, computing resources are allocated as necessary on a per-request basis. After the request is processed, the computing resources are unallocated, or returned.

### Data Structures

Various data structures may be used in conjunction with the software services. For example, various data structures may be used alone, or in combination, to store customer data/metadata, transaction data, etc.

Some example data structures include arrays, stacks, queues, linked lists, trees, graphs, tries, and hash tables.

### Software Services

A third party vendor or provider may provide payment processing software services. Software may be installed on terminals/clients or via backend/cloud servers, or both.

### Other Terminology

Herein a “plurality” refers to “one or more” of an element and does not impose any requirement for more than one element.

Various services may be pipelined, and executed in conjunction, in a non-blocking manner, for example.

The present disclosure provides several graphical user interfaces (GUIs) and/or interaction capabilities that provide easy and efficient methods to promote or allow discovery of, for example, local, hyperlocal, and/or relevant information. The present disclosure includes new, unique systems, methods and/or arrangements of GUI and/or GUI elements, configurations, and/or flows, that allow for greater efficiency, convenience, ease, accessibility, targeted accessibility to particular groups, balanced privacy, and/or speed of use and/or discovery. These disclosures may be used in environments such as social networking environments, applications, and/or systems.

Currently, there are no sufficient methods or systems to easily or efficiently discover information about, or interact with, nearby groups, communities, people, places, chat rooms, channels, message boards, pages and/or events using context or at a particular time/time period. For the purposes of this disclosure, the term “group(s)” will be understood to comprise any of, or combination of, groups, communities, people, places, chat rooms, channels, message boards, feeds, listings, pages and/or events. The current insufficiencies hinder the discovery of information in one's localized or hyper-localized context. The present disclosure helps solve these problems.

Groups, communities, people, places, chat rooms, channels, message boards, pages and/or events may be associated with context such as geographic context, type context, and/or a particular time or a time period context. For example, an apartment or dorm may be thought of as a housing community context in a particular location, and the resident profile comprises a set of people at any given time, which is dynamically changing. In another example, a concert may be thought of as a music event context in a particular location on a certain day and at/in a particular time or time period. Currently, there are no sufficient methods or systems for creating new chat rooms, channels, message boards, groups, and/or pages corresponding to these contexts that are easily discoverable, for example, and/or which allow interaction with other people in these contexts in approximately real-time or real time. For example, this disclosure allows for discovery and/or joining (and/or restriction) of groups based on user location and/or accessing those groups' crowdsourced stories. In some embodiments, a set of ephemeral content uploaded and/or created by users and/or group members can be organized as/in ephemeral content item collections. Ephemeral content may refer to any type of content that is accessible only for a predefined time period (e.g., second(s), minute(s), hour(s), day(s), etc.) and/or a predefined number of times (e.g., once, twice, etc.). An ephemeral content collection may include a set of ephemeral content and may be referred to as a “story,” “reel” and/or a set of “stories” and/or “reels.” A story and/or reel may be solo-authored (ie., created by a single user and/or has a single contributor) or jointly/shared-authored (ie., created by multiple users and/or has multiple contributors), for example. In another example, this disclosure allows for discovery and/or joining (and/or restriction) of groups based on user location, accessing those groups' crowdsourced stories, and/or automatically initiating and/or playing back those groups' crowdsourced stories easily, such as with one click, tap, and/or gesture.

It would be advantageous to be able to access methods and/or systems that provide and/or allow easy discovery of local and/or hyperlocal interaction capabilities on-demand and/or in approximate real-time or real-time based on one's location or selected location, for example.

It would be further advantageous to be able to access methods and/or a system that provides and/or allows easy discovery of local or hyperlocal information about communities, groups, people, places, and/or events, on-demand and/or in approximate real-time or real-time based on one's location or selected location, for example.

In some embodiments, a mobile application is provided. In some cases, a mobile application allows users to access capabilities from a mobile phone for example, which allows users to easily leverage features of current mobile technology. In some examples, mobile devices determine, gather, store, and/or utilize a user's current location or last known location or approximations of the aforementioned. This data can be helpful for providing users associated with their current context. In some cases, this location may be a precise location or a rough/approximate location.

### Authentication

In some embodiments, one or more login pages and/or authentication steps may be provided for accessing a mobile application. In one example, a user may be shown a login page for entering login information. In some embodiments, the login information may comprise an email address, wherein a user may be prompted to enter his email address. In some embodiments, the login information may comprise a user name, wherein a user may be prompted to enter his user name. In some embodiments, the login information may comprise a phone number, wherein a user may be prompted to enter his mobile phone number. This may be advantageous when the user likely has direct access to his mobile device when using mobile applications. A code may be created and delivered to the user's mobile phone number by SMS, email address, etc. Upon entry of the login code, a user may be authenticated. The code may be stored in a data store or database for example, which may exist, for example, on a server-side, proxy, edge, or cache location. The code may expire after a predetermined time. Therefore, a timestamp may also be stored with the code upon its creation. Upon a login attempt using the code, the timestamp may be compared with the login attempt time. If the difference between the login attempt time and the creation timestamp is less than the predetermined time, for example, then the login attempt may be validated or accepted. If the difference between the login attempt time and the creation timestamp is less than the predetermined time, for example, then the login attempt may be invalidated or denied.

In some embodiments, biometric authentication may be used. For example, a face detection and/or facial recognition step may be used to identify, authenticate, and/or validate a user login attempt.

Local or Hyperlocal Querying and/or Discovery

In some embodiments, systems and methods herein are capable of providing and/or returning nearby groups, events, and/or listings. For example, a user may wish to discover groups or events nearby to his current location. In some embodiments, hyperlocal querying methods and/or systems that allow efficient discovery of groups and other information are disclosed.

Location and/or Geo-Location

In some embodiments, a user location may be determined.

In some embodiments, a device location is determined from a user device. For example, a location associated with a user's mobile phone device or laptop device may be determined. In some cases, the location comprises a latitude and a longitude. In some embodiments, a user location is stored as a global variable in an application and/or in association with a user's device. A global variable may be stored in a user's device memory, such as device RAM and/or in a memory cache. The user location variable may be periodically updated. For example, a time period may be specified in an application after which a request to update a user device location and/or variable is made. For example, a timer period of 2 minutes may be specified. In this example, a request is made every 2 minutes to update a user device location and/or variable.

In some examples, a mobile application may provide instructions to request a user's permission to determine and/or access the user's current and/or last known location. In some cases, upon gaining user permission, a mobile application may provide instructions to then determine and/or access the user's current and/or last known location using, for example, a user's mobile device GPS coordinates and/or system. In some cases, power-saving options may be used that reduce or eliminate use of GPS and use cellular and Wi-Fi radios or that only reports location changes that exceed a predefined distance.

In some embodiments, a request to ascertain a user's permission may be an asynchronous method or function, and in some embodiments a request to ascertain a user's permission may be a synchronous method or function. In some embodiments, a request to ascertain a user's permission may be a blocking method or function, and in some embodiments a request to ascertain a user's permission may be a non-blocking method or function.

In some embodiments, a request to determine and/or access a user's permission may be an asynchronous method or function, and in some embodiments a request to ascertain a user's permission may be a synchronous method or function. In some embodiments, a request to determine and/or access a user's permission may be a blocking method or function, and in some embodiments a request to ascertain a user's permission may be a non-blocking method or function.

In some embodiments, a user's last known location may be stored, for example, in a server side database, data store, and/or data storage device. This allows, for example, an approximate or likely accurate user location to be used if a current user location is not yet available. In some examples, an asynchronous or synchronous method to determine a user location may take some time. In such an event, a user's stored last known location may be used until newer and/or more accurate current location data becomes available by the user's mobile device. Upon ascertaining newer and/or more accurate user location data, server-side data for last known position or location may be updated.

In some embodiments, a user-preferred location may be stored and used. A user-preferred location may be selected by a user and/or a mobile application service provider, for example.

### Local or Hyperlocal Context/Group/Channel Creation

In some embodiments, a user may be allowed to create and/or launch new groups, chat rooms, channels, message boards, communities, and/or pages. The user's current location or last known location may be ascertained and associated with the new groups, chat rooms, channels, message boards, communities, and/or pages. The user may be able to provide a name for the new groups, chat rooms, channels, message boards, communities, and/or pages to create an association with a local venue and/or event, for example. In some examples, a user may be able to create new groups, chat rooms, channels, message boards, communities, and/or pages for venues, establishments, buildings, apartment buildings, apartment floors, dorms, classes, music festivals, restaurants, bars, states, cities, counties, neighborhoods, blocks, streets, zip codes, regions, communities, colleges, schools, classes, rooms, offices, hotels, conferences, meetings, presentations, etc. This adds a contextual layer to the new groups, chat rooms, channels, message boards, communities, and/or pages. Similarly, an association of the user's current or chosen location during the creation of the new chat rooms, channels, message boards, and/or pages creates geographical context. This allows users to quickly and efficiently discover new groups, chat rooms, channels, message boards, communities, and/or pages, for example. This allows a cohesive and real time experience.

In one example, a user may be attending a music festival such as Austin City Limits (ACL) located in Zilker Park, Austin, Texas with latitude and longitude coordinates of 30.2670° N, 97.7730° W. The user may be allowed to access a mobile application from his phone which allows him to click a button or select an option to create a new channel for “ACL” when he is at Zilker Park for the event. He may select or enter a title such as “ACL.” A new group or channel may be created and associated information may be stored in a server-side database, for example. Associated information may include the context provided by the title and a location of the user's mobile device when the channel was created. In one example, the location may be the latitude and longitude described above.

The ACL group or channel may then be made available to other users within a certain distance or radius, for example, of the location associated with the channel described above. This allows for a quick, real time system to provide easily discoverable groups of channels to other users that may not be aware of groups or channels that may be associated with an area or event that is new to him, for example. In some examples, this would allow users to quickly and easily discover, meet, and/or interact with other people in the area at a particular time for common reasons and/or with common interests.

In another example, a user may live in an apartment building named The Bowie located in Austin, Texas with latitude and longitude coordinates of 0.2691° N, 97.7532° W. The user may be allowed to access a mobile application from his phone which allows him to click a button or select an option to create a new channel for “The Bowie” when he is at his apartment. He may select or enter a title such as “The Bowie.” A new group or channel may be created and associated information may be stored in a server-side database, for example. Associated information may include the context provided by the title and a location of the user's mobile device when the channel was created. In one example, the location may be the latitude and longitude described above.

The Bowie group or channel may then be made available to other users within a certain distance or radius, for example, of the location associated with the channel described above. This allows for a quick, real time system to provide easy, quick, efficient, and/or new discovery and/or exploration of groups or channels to other users that may not be aware of groups or channels that may be associated with an area or event that is new to him, for example. In some examples, this would allow users to quickly and easily discover, explore, meet, and/or interact with other people in the area or context at a particular time for common reasons and/or with common interests.

### Location Specification

In some embodiments, a user may be allowed to specify a position using, for example, a drop pin GUI, For example, a user may be allowed to place a marker, such as a “pin” at a selected point on a map GUI. The selected location may be associated with a group that the user is creating and/or has created.

### Data and Data Storage

In some embodiments, various data, data types, and/or data sets may be stored in one or more data storages and/or data storage devices as described herein.

### Local or Hyperlocal Context/Group Discovery

In some embodiments, groups, chat rooms, channels, message boards, communities, and/or pages may be retrieved, delivered, and shown to one or more users within, or approximately within, a certain radius or distance of a location associated with the one or more users, each of the groups, chat rooms, channels, message boards, communities, and/or pages. In some examples, the associated locations may be stored in a database table, such as a MySQL table, NoSQL table/collection, or other data storage device. A table may be queried against stored latitudes and longitudes associated with the stored locations, for example, to retrieve relevant table data and/or members. Embodiments herein thus allow for users to incrementally change location (ie., move around) and/or newly discover groups that come into range as he moves with a high level of precision. For example, embodiments herein allow users to newly discover local groups as he moves about within feet or meters, rather than simply by city or neighborhood.

In some embodiments, since a database table may have many members and a query may include using decimal values and/or a complex distance calculation, query optimizations may be advantageous to provide faster results.

In some embodiments, a rough or coarse query may be carried out to prune or exclude large portions of data and, afterwards, a fine query may be carried out to provide more precise results.

In some embodiments a spatial convenience function may be used. A spatial convenience function may return a minimum spherical distance between two points and/or multi-points on a sphere, in units such as meters. Such calculations may use a spherical earth and a configurable radius.

In some examples, a spatial convenience function (SCF) that returns a distance in meters (miles conversion may be carried out by multiplying the result by a value such as 0.000621371192, for example) may have a form such as:
select SCF (
   point(−97.75890000, 30.26110000),
   point(−97.65890004, 30.29110006)
)
   wherein a first value in each “point” input may be a longitude, and a second value may be a latitude, for example.

In some examples, a rough bounding box may be created around the current location or last known location of a user used as a query location. The bounding box may exceed and contain all points that are within a predetermined radius or distance of a query location. A query may be carried out against a database table containing locations of many members against the bounding box as a coarse query to reduce the number of results. Thereafter, a fine query, such as an SCF function may be run against the results. This can greatly increase speed of the overall querying compared with using an SCF function against the database table containing locations of many members. In some examples an SCF function may be a MySQL function such as ST_Distance_Sphere.

In some embodiments, appropriate data structures and/or data storage methods and/or systems may be utilized to reduce or eliminate the benefits of a course query. In some examples, a MySQL or NoSQL data storage device or system may be used. The data storage device or system may include data elements, members, and/or fields. In some embodiments, one or more geohashes may be calculated and/or stored in association with groups, rooms, channels, chatrooms, message boards, events, places, people, etc.

In some embodiments, users may be allowed to join local and/or hyperlocal groups, rather than simply “follow” a group. A user that has joined a group (ie., a group member) may be allowed and/or permitted to add and/or edit content associated with the group without additional permissions from other group members. In this way, content in the group may be crowdsourced and/or more easily crowdsourced (rather than group administrator-controlled, for example), the content which, in turn, becomes open and/or discoverable to other users.

### Geohashes

In some embodiments, a geohash is calculated and/or determined using a latitude and longitude.

In some cases, the geohash is an alphanumeric and/or Base 32 string of any length between 1 and 13 characters. In some cases, each character of a geohash string represents a bounding box which maps/corresponds to a particular geographic area when the world is divided into a rectangular grid. In some cases, each additional character in a geohash string adds additional specificity and/or precision by representing a smaller bounding box including a particular point, wherein the smaller bounding box is within a parent bounding box including the particular point. In other words, each additional character in a geohash string may represent a smaller child bounding box telescoped within a larger parent bounding box. In some examples, each character of a geohash string specifies one or 32 subdivisions of a prefix hash. For example, a geohash “abcd” is one of 32 four-character hashes fully within larger geohash “abc.”

In some cases, the geohash is a string between 1 and 13 characters encoding a region or bounding box including a point identified or defined by a latitude and longitude pair. In some cases a precision level is associated with the geohash or used for/during the calculation of the geohash.

In some cases, the precision level is predetermined and/or set according to an administrator preference or user preference. Both the latitude and longitude pair and one or more calculated geohashes may be stored in association with a user ID and/or group ID, for example. In some cases, such data is stored in a database or data store. In some cases, the database or data store may be partially or fully located in cloud infrastructure and/or accessible via cloud infrastructure.

Location and/or Geohash Queries

In some embodiments, systems and methods herein are capable of querying stored data based on one or more locations, such as a user's current location, using a latitude and longitude pair and/or one or more geohashes.

In some embodiments, groups, chat rooms, channels, message boards, communities, and/or pages may be ephemeral or expire after a particular time period. In some embodiments, users may be able to set an expiration time and/or date of the group, chat room, channel, message board, community, and/or page, or a time period for which the aforementioned may become unavailable and/or expire.

### Hierarchical Contexts/Groups

In some embodiments, groups, contexts, events, etc. described above may be subsets of, linked to, or connected to, other groups. For example, a group defined for an apartment building may be included within, linked to, or connected to, a group defined for a neighborhood in which the apartment building is located. Further, for example, a group defined for the neighborhood may be included within, linked to, or connected to, a group defined for a city in which the neighborhood is located. Further, for example, a group defined for the city may be included within, linked to, or connected to, a group defined for a county within which the city is located. Further, for example, a group defined for the county may be included within, linked to, or connected to, a group defined for a state in which the county is located.

As it can be seen in these examples, groups may possess a hierarchical relationship, parent-child relationship, grandparent-grandchild relationship, ancestor/descendent relationship, etc. Data relating to or reflecting such relationships may be stored in one or more databases and/or datastores. In some examples, data is stored in one or more MySQL or NoSQL databases or datastores. For example, tree, list, linked list, data structures may be used to store hierarchical relationships. It will be understood that data processing algorithms based on these advanced data structures may be leveraged. For example, tree data structure algorithms that allow for efficient search and/or selection may be leveraged in queries to deliver relevant results to users quickly. For example, a query to provide all groups in a city based on a user request may return all nodes of a subtree of a node corresponding to the city's group.

Reverse Geocoding and/or Geocoding

In some embodiments, reverse geocoding and/or geocoding may be used.

For example, a user's location may be determined based on a device location, associated methods/functions, and/or based on an entry of a location by a user. In some cases, the user's location may be identified by a latitude and longitude. A reverse geocoding method and/or function may use the latitude and longitude to determine an address and/or address parts. For example, a user's location may be used to reverse geocode an address, street, place, neighborhood, zipcode, city, county, state, and/or country.

In another example, a group location may be determined based on a device location, associated methods/functions, and/or based on an entry of a location by a user. In some cases, the group's location may be identified by a latitude and longitude. A reverse geocoding method and/or function may use the latitude and longitude to determine an address and/or address parts. For example, a group's location may be used to reverse geocode an address, street, place, neighborhood, zipcode, city, county, state, and/or country.

Local and/or Hyperlocal Visualization

In some embodiments, local and/or hyperlocal visualizations may be provided.

For example, a user may be allowed to view nearby groups. Nearby groups may be identified and/or determined based on methods described herein.

In some examples, a nearby groups visualization may be updated as a user moves around within an environment. For example, as a user moves, some groups that were within a particular distance based on a particular distance query may fall out of range while others may come into range, and a nearby groups visualization may be updated periodically and/or based on a threshold of user movement/location change.

In some examples, local and/or hyperlocal visualizations may comprise lists of elements and/or maps showing markers (such as “pins) corresponding to elements. In some cases, elements may comprise groups or data corresponding to groups.

Group Information and/or Data Visualization

In some embodiments, a user may be allowed to share information and/or data to a particular group and/or view information and/or associated with a group. For example, group members may be able to share information and/or data to a particular group with which they are associated and, for example, group members associated with that particular group may be allowed to view the information and/or data. In this example, the shared information may be public only to other group members. In some cases, group members may have no previous connection with a group member sharing information. For example, group members consuming information shared by another group member may not be friends, followers, and/or connections of each other. In this example, sharing of content only between group members may advantageously allow for efficient discovery of new information and/or facilitate new connections.

Examples of information and/or data include content, text, images, media, video, streams, streaming data, live streams, etc. In some embodiments, information and/or data may be associated with a visualization time and/or expiration time, providing an ephemeral effect experience for those consuming the information and/or data. For example, an image may be shared to a group with a 5 second visualization time, allowing members of the group to visualize the image for 5 seconds.

### Example 1

In first simple example according to some embodiments, Shawn is a group member of multiple groups, including a group named “West China Tea” corresponding to a tea house that he frequents at a first address, a group named “Capital Factory” corresponding to a co-working space that he works from at a second address, and a group named “Sparq on Rio” corresponding to an apartment complex in which he lives at a third address. The three groups may be considered different contexts. The three groups can only be discovered by users that are not current group members by being associated with a location within a predefined distance of each of the groups, respectively, and/or by receiving an invite code from a current group member.

Melissa also frequents West China Tea and is a group member of only West China Tea. Hayah also lives at Sparq on Rio, and she is a group member of only Sparq on Rio. Shawn, Melissa, and Hayah are not friends, followers, and/or connections of each other, and did not know each other, at a first time point, such as Jan. 1, 2024.

As a group member, Shawn is allowed to share content with the West China Tea group. Shawn shares content associated with him exclusively with the West China Tea group. For example, Shawn exclusively shares a first picture and/or a video with West China Tea. The first picture and/or video is only available to other members of West China Tea. For example, Melissa may be able to view the content, but Hayah is not able to view the content.

As a group member, Melissa is allowed to share content with the West China Tea group. Melissa shares content associated with her exclusively with the West China Tea group. For example, Melissa exclusively shares a second picture and/or a video with West China Tea. The second picture and/or video is only available to other members of West China Tea. For example, Shawn may be able to view the content, but Hayah is not able to view the content.

A group member of West China Tea may be able to select a GUI element which initiates display of content shared with West China Tea. For example, a query may be performed to retrieve and aggregate one or more content items identified as being associated and/or shared with West China Tea content in response to the group member selection and/or action. The one or more content items may be considered crowdsourced, or substantially crowdsourced, as deriving from one or more of multiple group members, rather than only a group administrator(s) and/or group member(s) with group administrator access to the group, only a group creator(s) and/or group member(s) with group creator access, or only after receiving approval or invitation from another group member such as a group creator, moderator, and/or administrator. In other words, in some embodiments, users do not need to know and/or have any connection with any group members beforehand and/or do not need any approval and/or any invitation (ex., invite code, invite link, invite QR code, invite email, invite SMS, etc.) from any other group members to discover, join, and/or share content to, or with, the respective group. In some embodiments, users may gain access to discover, join, and/or share content to, or with, respective groups based on the user's location, as described herein. The absence of such requirements is advantageous because friction, discovery barriers, and/or barriers to entry are removed/eliminated for users.

By allowing crowdsourcing of content items, it becomes advantageously easier to provide and/or obtain a more real-time or live impression of current events or happenings. For example, a group member has an increased chance to see what is currently happening in one or more of his associated contexts when many others are contributing to the group content. In some embodiments, allowing crowdsourcing of content into groups that are discoverable by a user's proximity to a location associated with the group, as described herein, allows discoverability of relevant and useful content for group members. In some embodiments, allowing crowdsourcing of content into groups that are discoverable by a user's proximity to a location associated with the group, as described herein, and further where that content is rapidly and/or easily aggregated, sorted, and/or orderly displayed (such as based on a timer as described herein) according to a particular sequence (for example, reverse chronologically) allows discoverability of relevant and useful content for group members, such as content with a greater likelihood of being real-time and/or closer to real-time.

The one or more content items may be processed by one or more text, image, video, and/or other content type moderation services and/or microservices. For example, a group member may post an image and/or video, and the image and/or video may be processed using an image and/or video content moderation service. For example, one or more API calls, as described herein, including a URL for the image and/or video may be delivered to an image and/or video content moderation service, which may flag, tag, return a data item, identify and/or label the image and/or video as inappropriate, etc. In some embodiments, a content moderation service comprises a service and/or microservice with access to one or more artificial intelligence and/or machine learning models trained to identify inappropriate content. In some embodiments, a response to one or more API calls may be used to determine whether or not to store, accept/deny, remove, block the content's creator/poster, and/or modify content. For example, an API call response may return a label and/or data item identifying the content to include nudity. Based on the label and/or data item, the content may be automatically denied uploading/posting, automatically removed, and/or the uploading user/creator/poster may be automatically banned from one or more platforms or services.

The display of a first content item, of the one or more content items identified as being associated and/or shared with West China Tea, may be displayed in response. The selection to display the first content item may also be associated with initiation of a timer countdown based on a predefined amount of time (for example, 5 seconds). After the end of the timer countdown, the display of the first content item may be automatically discontinued. The display of a second content item, of the one or more content items identified as being associated and/or shared with West China Tea, may be displayed in response.

In this simple example, a group member of West China Tea selects a GUI element. In response, the display of the first picture and/or a video shared by Shawn begins and a 5 second countdown timer also begins. After the countdown ends, the display of the first picture and/or a video is automatically discontinued. In response, the display of the second picture and/or a video shared by Melissa begins and a 5 second countdown timer also begins. After the countdown ends, the display of the second picture and/or a video is automatically discontinued.

In this way, group members are allowed to view a sequence (which automatically plays and/or continues) of content items associated with each group for which they are members. Further in this way, group members are allowed to quickly view and/or discover a set of content items from many others with whom they have a context in common while maintaining a certain level or privacy and/or restriction of shared content (ie., shared content is not globally available to all users and/or non-group members).

### LLMS

In some embodiments, large language models (LLMs) may be used for various purposes. In some cases, LLMs may be used for content moderation, such as for user generated content moderation. For example, user generated text may be forwarded for processing using an LLM hosted at a remote location, cloud location, proxy location, and/or locally on a device such as a user device.

In some embodiments, systems and/or methods herein may comprise, or reference, terms, policies, and/or rules to be applied in moderation processes. LLMs may be trained according to the terms, policies, and/or rules to determine potential violations.

API Calls and/or Data Processing

In some embodiments, one or more API calls may be made from an end-user application based on end-user activity. In some examples, upon login and/or visiting particular pages, an API call may be made to a backend, edge, and/or cloud system to process and/or execute queries and/or process data based on the end-user's current location. In some examples, upon login and/or visiting particular pages, data based on the end-user's current location may be processed locally on the end user's device using, for example, code provided within, or as part of, an application such as a downloaded application.

In some embodiments, upon making a particular request and/or visiting a page, UI, GUI, and/or view in an application such as a mobile and/or desktop application,

It will be understood that one or more of the API calls described herein may be asynchronous.

Local and/or Hyperlocal Advertising

In some embodiments, local and/or hyperlocal shopping and/or advertising methods are disclosed. It would be advantageous to allow for more efficient and/or targeted advertising. In some cases, it would be advantageous to allow online and/or web based tools to allow for more efficient local or hyperlocal advertising. For example, it would be useful for a local venue, such as a local apparel store, to target users with advertisements (“ads”) that spend time in nearby locations or at the store. Advertisements may comprise, for example, offers, deals, promotions, and/or sales. In some examples, advertisers may be allowed to select particular groups and/or channels in an app or web-based platform to which an ad may be displayed.

Management Consoles, GUIs, and/or CRMs

In some embodiments, one or more management consoles, GUIs, and/or customer relationship management (CRM) tools may be provided.

For example, one or more GUIs may be displayed that allow users and/or advertisers to process the creation, modification, targeting, management, cost and/or delivery of one or more ads.

Customer relationship management (CRM) and/or web based software or tools are useful for a variety of tasks. New arrangements, configurations, and/or combinations of web tools, components, and/or flows, for example, can allow new capabilities for solving emerging problems and/or allow more efficient handling of current problems and/or tasks in various fields.

One such field relates to e-commerce. There is a growing need for systems and methods which can handle e-commerce processes more easily. For example, product sales may become more difficult as the internet space becomes more cluttered. Marketing, for example, of products online may grow increasingly difficult with a growing number of options.

A further problem exists in that merchants are often unable to easily technically connect online platforms such as websites with marketing channels or methods. Doing so may be cost prohibitive or technically cumbersome. Merchants may be unable to create and/or manage valuable technical additions or systems. Yet another problem is that merchants are often not easily able to tap into the network and marketing power of influencers, and, conversely, influencers are not easily able to capitalize on this capability.

What is needed are systems and methods that easily allow merchants to leverage marketing capabilities of other entities and/or technical systems. In one example, it would be very powerful for a technically unskilled and/or bootstrapped merchant to be able to tap into a large following or network of another associate to sell products in exchange for a commission. In such an example, it is also advantageous for the associate to monetize his/her following quickly and easily. Embodiments described herein solve the aforementioned problems.

In some embodiments, users, customers, merchants, affiliates, associates, and/or service providers may be able to create web based accounts.

Web based and/or web accessible accounts may access one or more databases and or datastores, for example a backend database access via cloud infrastructure described herein. For example, a MySQL database may store user profiles, one or more user IDs or unique identifiers, credentials, and/or details associated with the user. Users may register and/or access/login to user accounts via web based registrations, etc.

In some embodiments, web based account portals and/or consoles and various management GUIs as described herein may be used to manage, analyze, handle, and/or share data, information, and/or content described herein.

Associate and/or Influencer Accounts, Consoles, GUIs, and/or CRMs

In some embodiments, a user, affiliate, agent, influencer and/or associate may be provided access to one or more web based account portals, consoles, GUIs, and/or CRMs.

In some embodiments, an account and/console may provide a management console that allows a user such as an associate to manage products or services which he is marketing or managing, which may include products or services provided by a merchant. In some embodiments, a listing of products and/or services may be displayed.

The user may be allowed to enter product related information. Some examples of product related information may be product images or videos, user images videos such as images wherein the user is modeling the product, links to products on a merchant site, descriptions, prices, etc. A user may be allowed to upload an image, for example, of the product or product page as it appears on a merchant's website. The user may be allowed to add his own description.

In some embodiments, the system may automatically extract product related information from a merchant's website for display in a user's console. For example, product images and/or webpage snapshots may be gathered from product webpage HTML. Similarly, product descriptions and/or prices may be automatically extracted from a product page HTML.

A referral or affiliate hyperlink may be automatically created for each product. The hyperlink may include a product identifier, associate identifier, and/or code such as a promo code, for example. The hyperlink may be shown along with each product along with icons or links allowing direct sharing to social media sites, email, SMS, messaging apps, etc.

Each product in a list may, for example, link to a detailed product page. A detailed product page may display more product information, allow editing of product related information, and provide product sales and/or marketing performance visualizations and/or metrics. For example, a number of sales pending and/or completed using a user or associate's referral link, commissions earned for referrals, engagement with a product page displayed to customers such as link or page views and/or number of times customer's shared the user or associate's referral link.

In some embodiments, the system then allows for viral campaigns to be developed easily without the requirement of code or development ability by users, associates, and/or merchants.

In some embodiments, a user, affiliate, and/or associate may contact or be in communication with a merchant and a relationship may be established.

In one example, a new associate that may have a large network or following may connect with a merchant. For example, an associate may be allowed to select an option or function in a web based account to contact a merchant by entering a merchant's email address or phone number. The system may create or prepare a communication such as an email or text message to deliver to the merchant using the contact information. In some embodiments, a communication and/or notification may be delivered to a merchant account and/or console. The communication may be an invitation to connect and/or join the system and/or establish an initial relationship.

Merchant, Advertiser, and/or Seller Accounts, Consoles, GUIs, and/or CRMs

In some embodiments, a merchant may be provided access to one or more web based account portals and/or consoles.

In some embodiments, an account and/console may provide a management console that allows a merchant to manage products and/or services which he is allowing an associate to market or manage.

In some embodiments, a listing of notifications may be displayed, including invitations or requests to connect with associates. Merchants may be able to view associate profiles and/or ratings/reviews and vice versa.

In some embodiments, a listing of merchant products being marketed by associates may be displayed. A merchant may be able to manage the product and/or provide or revoke access for an associate.

Each product in a list may, for example, link to a detailed product page. A detailed product page may display more product information, allow editing of product related information, and provide product sales and/or marketing performance visualizations and/or metrics. For example, a number of sales pending and/or completed using a user or associate's referral link, commissions earned for referrals, engagement with a product page displayed to customers such as link or page views and/or number of times customer's shared the user or associate's referral link.

### Store

In some embodiments, a store, product listing, blog, webpage, app page, and/or store-type page may be created for a user, affiliate, influencer, and/or associate.

An associate may be able to manage this page from his account console.

An associate may be able to select a page theme controlling the appearance of his store page.

A store page may automatically and dynamically populate according to the hosting associate's data. For example, the associate's marketed products and descriptions, price, and/or discounts may be displayed according to a page theme selected. A webpage, app, and/or CSS template may be used to present a respective associate's data, products, and/or store. In some embodiments, a user or associate may be able to launch a live webpage store and/or marketplace with one click. This reduces or eliminates the need for a user or associate to possess any web development knowledge and/or capabilities. Similarly, a store or marketplace template may be used to create an app page for a user or associate. This may make marketing of products easy for the user or associate. For example, the associate may be able to simply share a URL for his store page, or simply click on a sharing icon to share his page.

### Performance Metrics

In some embodiments, performance metrics and/or visualizations may be provided in, for example, a merchant console, an affiliate console, on a store page, on an advertisement page, etc. For example, an associate's store page performance may be shown including, for example, number of page visitors, number of clicks on each page location, trends and/or trends over time, etc. This information may be useful in allowing, for example, a merchant to decide whether he would like to use the marketing or advertising services provided by an associate. It may also allow a merchant to track associates' performances over time, for example.

Transactions and/or Fee Settings

In some embodiments, an associate may be allowed to set a fee associated with various product advertisements for his store page and/or for specific positions on his page.

### Purchases

In some embodiments, purchases may be credited to a referrer or associate by gathering data from customers. For example, when a customer selects a link from an associate's product page, one or more pages may open. In some embodiments, selection of a link may cause two URLs to be opened, using, for example, JavaScript:
<a href=“#” onclick=“window.open(‘https://merchantproductpage.com’); window.open(‘https://referraldataform.com’);”>Buy</a>

A user may be prompted to enter, for example, a receipt, order, or confirmation number in a data form from a referral system URL upon completion of purchase from the merchant product page URL. This allows the merchant product purchase and checkout process to remain intact and avoids the need to modify the merchant website and/or code.

In some embodiments a referral system data form may be a pop-up window.

In some embodiments, customers may be redirected to a referral system page when selecting a product to purchase. The referral page may provide an area or form to gather data as described above and provide instructions to enter pertinent data after completing purchase of the product at the merchant website. A second link may be provided to the merchant product page along with the instructions.

In some embodiments, customers may create and/or be provided access to their own accounts tracking purchases, products, products of interest, saved products, and statuses. The customer may be allowed to provide the data described above in connection with products in his account.

In some embodiments, payment may be integrated at the merchant site. For example, upon customer checkout, a customer payment may be reduced to reflect a discount or promo provided by, or for working with or through, the associate or affiliate. During the payment, a portion or commission may be paid to the associate or affiliate. Additionally, during the payment, a portion or commission may be paid to one or more software service providers, such as a payment system provider and/or an affiliate system provider.

In some embodiments, customers may be able to complete purchase of a product with one click at, for example, a merchant website or store page, or an associate or affiliate webpage or store. For example, customer payment and shipping details may be stored and used as default checkout information. Upon selection or clicking to purchase, a customer may complete a purchase of a product shared with him.

In some embodiments, an associate may complete or carry out purchases for customers. Customers may pay and/or checkout at an associate webpage or store, as described herein. Customers may be able to complete purchase of a product at a store with one click as provided herein. A merchant may approve an associate or affiliate as a reseller.

In some embodiments, payment may be integrated at the associate or affiliate site. For example, upon customer checkout, a customer payment may be reduced to reflect a discount or promo provided by, or for working with or through, the associate or affiliate. During the payment, a portion or commission may be paid to the associate or affiliate and another portion paid to the merchant of the product. Additionally, during the payment, a portion or commission may be paid to one or more software service providers, such as a payment system provider and/or an affiliate system provider.

In some embodiments, merchants may have accounts within, or linked to, associate accounts to allow payouts to merchants from associate collected payments for products.

In some example embodiments, a software service may be provided. The software service may include a merchant account and/or console that allows merchants to enter promotions, deals, sales, etc. for products and/or services. Entered information may be used to create a product, service, and or deal page. Merchants may be allowed to specify a referral credit. A referral credit may be delivered or paid to a referring associate and/or agent, for example, upon a sale of a product or service that is credited to a referring agent or associate. The referral credit may be shown on the product, service, or deal page.

In some embodiments, the software service may include an account and/or console for users, associates, and/or agents. One or more referral codes or links may be created for associates or agents. The referral codes and or links may be saved in a database or datastore, such as a MySQL database, in association with a user account for the associate or agent, for example. Users, associates, and/or agents may select a product or service available from a merchant, based on a deal page and referral credit, for example. A referral code, number, or identifier may be generated in association with the product and/or service. Thus, a referral code may be a unique code or identifier associated with one or more of a referring agent, a particular product/service from a particular merchant, and/or a particular locality. A referral url or link may be generated with a referral code embedded. Such a url or link may be a shortened url or link. Such a url or link may link to a product, service, and/or deal page.

A product, service, or deal page may allow a visitor to purchase the product, service, or deal. Upon a purchase action, if the url or link used for the page contains a referral code, the referral code may be used to credit a referring agent with the referral credit. Upon checkout, the purchase payment may be split and delivered to various parties, automatically. In some examples, a referral credit may be deducted from the price and delivered or credited to an agent or associate account. In some examples, a fee may be deducted from the price and delivered to the software service provider. In some examples, a tax may be deducted from the price and delivered or credited to a selected party. A remainder of a purchase price after one or more such deductions may be delivered or credited to a merchant account.

In some embodiments, products and/or services may be associated with a particular locality. For example, a dentist may be based in Austin, Texas. In such cases, products/services may be more relevant to nearby customers, visitors, users, associates, agents, etc. Therefore, a locality may be associated and/or entered by a merchant posting the product or service. A software service provider may allow searching products/services by locality or region. For example, customers and associates/agents may be allowed to select Austin, Texas to view products/services associated with that locality. This is advantageous because local influencers may be allowed to select and market products/services more effectively.

### Hyperlocal Application

In some embodiments, an application, such as a mobile or web application, may be provided.

The application may deliver local and/or hyperlocal information.

In some embodiments, a mobile application may be provided that allows users to interact with other users and/or merchants, for example. In some examples, users may be able to chat or provide messages on a massage board, for example.

In some embodiments, channels, pages, or chat rooms may be provided to users based on a user's geographic location. In some examples, a predetermined radius may be used to calculate a distance from a user, and channels, pages, or chat rooms associated with a location that is within the calculated distance may be displayed to the user during a user session.

In some embodiments, a user may be allowed to add new channels, pages, or chat rooms associated with a location. In one example, the location may be the user's current location. The associated location and the new channel, page, or chat room associated with a location may be stored in a database or datastore, for example. This new channel, page, or chat room may then be made available based on the associated location to other users when they are nearby using a similar process as described.

Engagement Metrics and/or Feedback

In some embodiments, engagement metrics may be calculated, determined, provided and/or displayed. For example, engagement metrics may comprise a number of ad views for a particular ad. In some cases, it would be advantageous for an advertiser to determine the return on investment (ROI) for purchasing and/or running an ad. Therefore, tools that allow users and/or advertisers to more easily interact with, determine, view, and/or understand engagement metrics are useful.

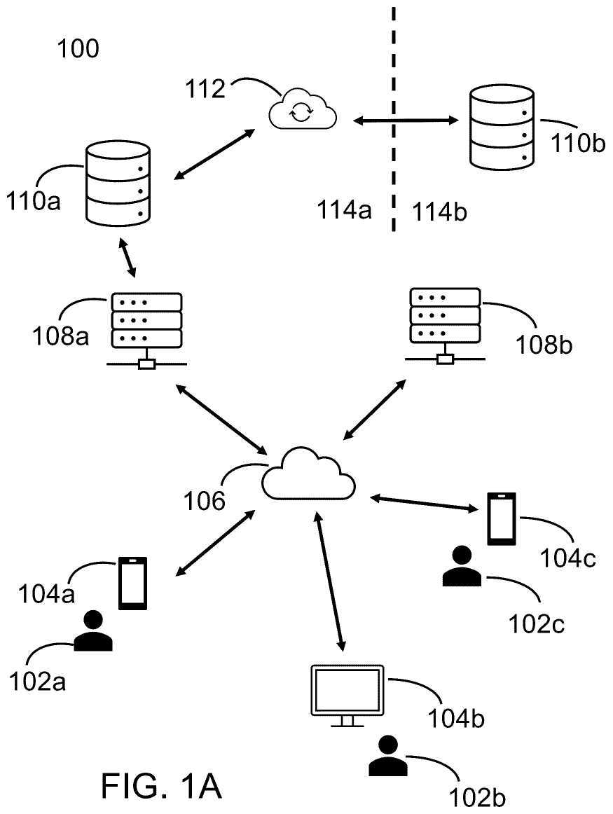

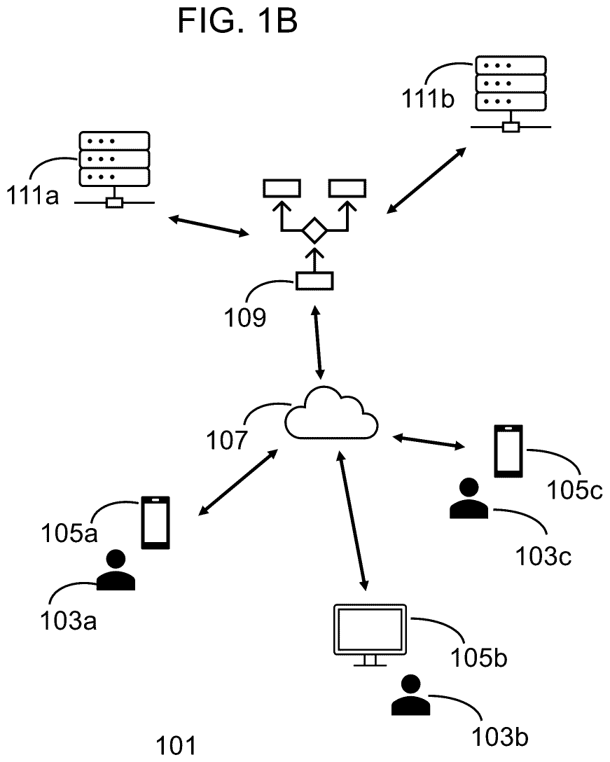

FIG. 1A is a diagram showing a network system 100 according to some embodiments.

In some embodiments, one or more users may interface and/or interact with a network and/or network system via one or more respective user devices. For example, users 102a-102c are shown along with respective user devices 104a-104c. Users 102a-102c may interact with network system 100 by using user devices 104a-104c. In some embodiments, a user device comprises a mobile device, laptop, personal computer (PC), tablet, headset, augmented reality or virtual reality (AR/VR) headset or device, implant, projection device, simulation device, and/or other computing device.

In some embodiments, one or more applications, such as mobile or web applications, are installed and/or accessible via one or more user devices. For example, user device 104a and user device 104c may be installed with a mobile application and/or be able to access a web application via a browser, for example. In another example, user device 104b may be able to access a web application.

In some embodiments, one or more users, via one or more user devices may be in communication with a network which may be in communication with one or more resources, such as cloud resources, proxy resources, servers, microservices, software, hardware, and/or system resources. For example, user devices 104a-104c may access network 106.

In some embodiments, a network may access, connect, and/or be in communication with one or more resources. For example, network 106 may access and/or be in communication with microservices 108a-108b. In some embodiments, microservices and/or microservices infrastructure comprise one or more servers, processors, databases, software resources, hardware resources, and/or data storage devices. In some embodiments, different instances of microservices provide the same or similar microservices. In some embodiments, different instances of microservices provide the different microservices.

In some embodiments, a microservice may access, connect, and/or be in communication with one or more resources. For example, microservice 108a may be in communication and/or access one or more data storage devices 110a-110b. In some embodiments, a data storage device comprises a database or other data storage resource. In some embodiments, data stored in a data storage device may be copied, backed up, and/or propagated to another data storage device in the same or another region by a copy, backup, and/or propagation service. For example, data stored in a data storage device 110a in region 114a may be copied, backed up, and/or propagated to data storage device nob in region 114b by copy, backup, and/or propagation service 112.

FIG. 1B is a diagram showing a network system 101 according to some embodiments.

In some embodiments, one or more users may interface and/or interact with a network and/or network system via one or more respective user devices. For example, users 103a-103c are shown along with respective user devices 105a-105c. Users 103a-103c may interact with network system 101 by using user devices 105a-105c. In some embodiments, a user device comprises a mobile device, laptop, personal computer (PC), tablet, headset, augmented reality or virtual reality (AR/VR) headset or device, implant, projection device, simulation device, and/or other computing device.

In some embodiments, one or more applications, such as mobile or web applications, are installed and/or accessible via one or more user devices. For example, user device 105a and user device 105c may be installed with a mobile application and/or be able to access a web application via a browser, for example. In another example, user device 105b may be able to access a web application.

In some embodiments, one or more users, via one or more user devices may be in communication with a network which may be in communication with one or more resources, such as cloud resources, proxy resources, servers, microservices, software, hardware, and/or system resources. For example, user devices 105a-105c may access network 107.

In some embodiments, a network may access, connect, and/or be in communication with one or more resources. For example, network 107 may access and/or be in communication with microservices 111a-111b. In some embodiments, microservices and/or microservices infrastructure comprise one or more servers, processors, databases, software resources, hardware resources, and/or data storage devices. In some embodiments, different instances of microservices provide the same or similar microservices. In some embodiments, different instances of microservices provide the different microservices. For example, microservices 111a and 111b may comprise instances providing the same microservices.

In some embodiments, a microservice may access, connect, and/or be in communication with one or more resources. For example, microservice 11a may be in communication and/or access one or more data storage devices. In some embodiments, a data storage device comprises a database or other data storage resource. In some embodiments, data stored in a data storage device may be copied, backed up, and/or propagated to another data storage device in the same or another region by a copy, backup, and/or propagation service. For example, data stored in a data storage device in a first region may be copied, backed up, and/or propagated to data storage device in a second region by copy, backup, and/or propagation service.

In some embodiments, a network may access, connect, and/or be in communication with one or more resources. For example, network 107 may access and/or be in communication with microservices 111a-111b through one or more load balancers 109. In some embodiments, one or more load balancers 109 may be used to route traffic to one or more microservices 111a-111b.

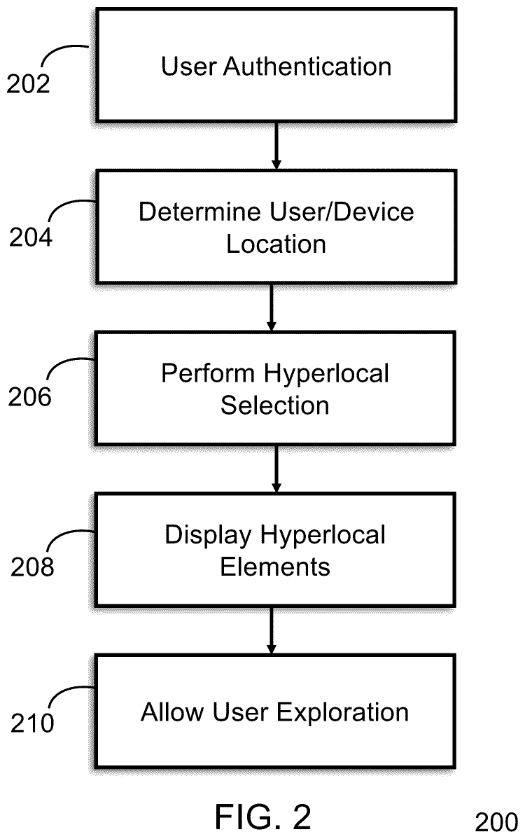

FIG. 2 is a flowchart showing a general data and/or content discovery process 200 according to some embodiments.

In some embodiments, an application and/or service, such as a mobile application/service, server application/service, cloud application/service, microservice, and/or web application may allow user authentication. For example, data and/or content discovery process 200 may comprise user authentication 202. In some embodiments, user authentication may comprise a first step in a process. In some embodiments, user authentication may comprise a requirement to access some or all of an application, such as a mobile and/or web application, for example. In some embodiments, user authentication may comprise one or more login procedures and/or requirements. In some embodiments, user authentication may comprise email, phone, text (SMS) login and/or verification processes. For example, a unique login code may be generated and/or delivered to a user email account and/or phone number (via SMS message for example). In some embodiments, a unique login code may be a random string comprising numbers and/or alphanumeric characters. In some embodiments, a generated login code may be stored in one or more data storage devices using a service such as a microservice. In some embodiments, a login code may comprise a string of predefined length. In some embodiments, a user may be authenticated upon entering a correct login code via one or more GUIs matching a generated login code. In some embodiments, an application and/or service, such as a mobile application/service, server application/service, cloud application/service, microservice, and/or web application may require user authentication. In some embodiments, an application and/or service, such as a mobile application/service, server application/service, cloud application/service, microservice, and/or web application may omit and/or skip user authentication. In some embodiments, an authenticated user may be associated with one or more sessions comprising, for example, one or more session cookies and/or session variables. In some embodiments, session variables comprise one or more key-value pairs that may be persistently stored across launches of an application.

In some embodiments, an application and/or service, such as a mobile application/service, server application/service, cloud application/service, microservice, and/or web application may allow for determining a user and/or user device location. For example, data and/or content discovery process 200 may comprise determining and/or inferring a user device location 204.

In some embodiments, determining and/or inferring a user device location 204 may comprise one or more processes, methods, routines, and/or subroutines.

In some embodiments, an application and/or service, such as a mobile application/service, server application/service, cloud application/service, microservice, and/or web application may require determining a user and/or user device location. In some embodiments, an application and/or service, such as a mobile application/service, server application/service, cloud application/service, microservice, and/or web application may not require, skip, and/or omit determining a user and/or user device location.

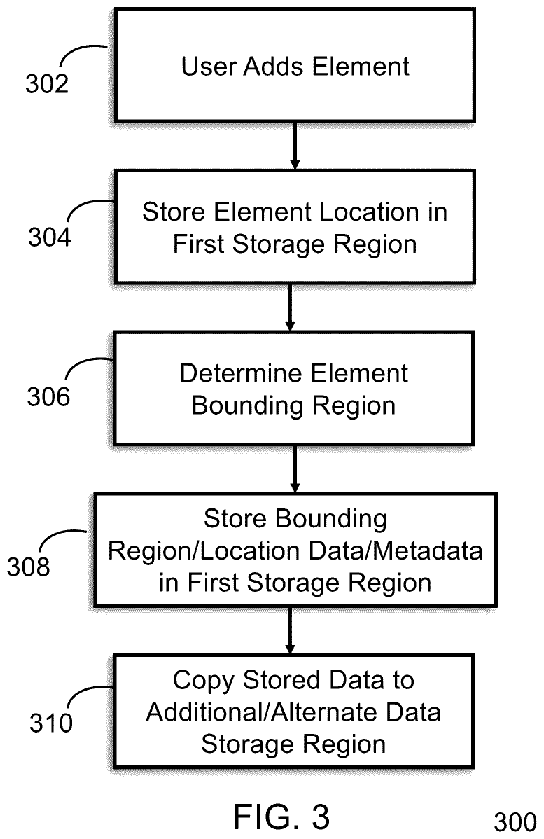

In some embodiments, an application and/or service, such as a mobile application/service, server application/service, cloud application/service, microservice, and/or web application may allow for performing selection of data and/or metadata associated with local and/or hyperlocal information. For example, data and/or content discovery process 200 may comprise performing hyperlocal selection 206. In some embodiments, selection of data and/or metadata associated with local and/or hyperlocal information comprises one or more processes and/or methods described herein. For example, selection of data associated with local and/or hyperlocal information may comprise one or more processes such as those described in FIGS. 3-5.

In some embodiments, an application and/or service, such as a mobile application/service, server application/service, cloud application/service, microservice, and/or web application may allow for display data and/or metadata associated with local and/or hyperlocal information. For example, data and/or content discovery process 200 may comprise display hyperlocal elements 208. In some embodiments, data and/or metadata associated with local and/or hyperlocal information may comprise one or more names (such as a group or channel name), location, members, posts, comments, replies, stories, images, videos, media, deals, offers, ads, etc.

In some embodiments, content may be shared between users. For example, a post may be shared by a sharing user with another receiving user using a GUI element such as a share button. In response, the post and/or a link may be shared with the receiving user. In some embodiments, a comment (such as a comment on a post) may be shared by a sharing user with another receiving user using a GUI element such as a share button. In some embodiments, a comment (such as a comment on a post) along with a context (such as the post with which the comment was made in regards) may be shared by a sharing user with another receiving user using a GUI element such as a share button. For example, the comment may be shared in connection with the post and/or including the post. For example, a post image and/or text may be shown, along with the comment attached and/or connected. In some embodiments, other content may be truncated from the context. For example, other comments on the post which were not the target of the sharing action may be truncated and/or excluded.

In some embodiments, an application and/or service, such as a mobile application/service, server application/service, cloud application/service, microservice, and/or web application may allow for user exploration of data and/or metadata associated with local and/or hyperlocal information. For example, data and/or content discovery process 200 may comprise allowing user exploration 210.

FIG. 3 is a flowchart showing a data and/or content addition process 300 according to some embodiments.

In some embodiments, an application and/or service, such as a mobile application/service, server application/service, cloud application/service, microservice, and/or web application may allow for performing addition of data and/or metadata (such as data and/or metadata associated with local and/or hyperlocal information). For example, data and/or content addition process 300 may comprise allowing a user to add one or more elements 302. In some embodiments, a user may be allowed to add one or more elements via one or more GUIs. In some embodiments, an operator and/or service provider may be allowed to add one or more elements via one or more GUIs. For example, a user may be allowed to add data via one or more input fields in one or more GUIs. In some embodiments, an input field and/or other GUI element may be provided for input of a name, such as a group or channel name. In some embodiments, an input field and/or other GUI element may be provided for input of a location, such as group or channel location. For example, in some cases a user may be able to input a location, select a location from a list and/or auto-populated GUI element, select a location on a map such as by clicking/selecting a point on a map and/or dropping or moving a pin/marker on a map. In some embodiments, an input field and/or other GUI element may be provided for input of a name, such as an event name. In some embodiments, an input field and/or other GUI element may be provided for input of a date and/or time, such as an event start and/or end date and/or time.

In some embodiments a location, such as a latitude and/or longitude may be automatically determined based on user selections and/or additions. For example, a user's selection of a point on a map may be translated and/or converted into a latitude and/or longitude. For example, an API call and/or process may be triggered to convert a user's selection of a point on a map into latitude and/or longitude coordinates and/or an address. In some cases, latitude and/or longitude coordinates may be used in or with a reverse-geocoding process and/or API call.

In some embodiments, a location associated with a user entry, action, addition, and/or selection may be stored, such as in a first storage region in a first geographical region. In some embodiments, a location associated with a user entry, action, addition, and/or selection may be stored, such as in a second and/or additional storage region in a second geographical region. For example, data and/or content addition process 300 may comprise storing a location, such as a location associated with a user action and/or addition, in a first storage region 304.

In some embodiments, an application and/or service, such as a mobile application/service, server application/service, cloud application/service, microservice, and/or web application may execute and/or include processes comprising determining a bounding region for a location associated with a user entry, action, addition, and/or selection. For example, data and/or content addition process 300 may comprise determining a bounding region for an element 306, such as a group or channel, added by a user. For example, a bounding region may be determined according to methods and/or processes described herein.

In some embodiments, a bounding region associated with a location and/or user entry, action, addition, and/or selection may be stored, such as in a first storage region in a first geographical region. In some embodiments, a bounding region associated with a location and/or user entry, action, addition, and/or selection may be stored, such as in a second and/or additional storage region in a second geographical region. For example, data and/or content addition process 300 may comprise storing a bounding region associated with a location, such as a location associated with a user action and/or addition, in a first storage region 308.

In some embodiments, an application and/or service, such as a mobile application/service, server application/service, cloud application/service, microservice, and/or web application may allow or cause copying, propagating, and/or storing stored data from one storage region, such as a first geographical region, into a second storage region, such as a second storage region. For example, data and/or content addition process 300 may comprise copying and/or propagating stored data from a first storage region to an additional and/or alternate storage region 310.

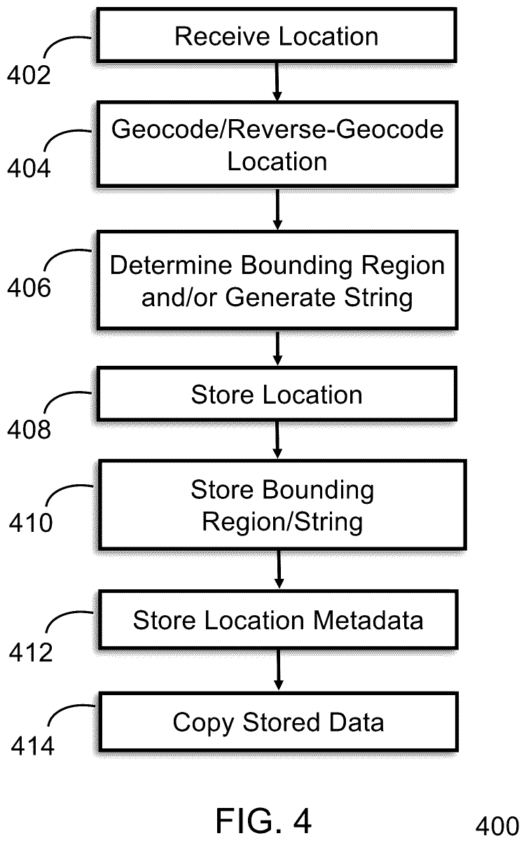

FIG. 4 is a flowchart showing a location data and/or content addition process 400 according to some embodiments.

In some embodiments, an application and/or service, such as a mobile application/service, server application/service, cloud application/service, microservice, and/or web application may execute and/or include processes comprising receiving a location associated with a user entry, action, addition, and/or selection. For example, location data and/or content addition process 400 may comprise receiving a location associated with an element 402, such as a location associated with a user, group, or channel.

In some embodiments, an application and/or service, such as a mobile application/service, server application/service, cloud application/service, microservice, and/or web application may execute and/or include processes comprising geocoding and/or reverse-geocoding a location associated with a user entry, action, addition, and/or selection. For example, location data and/or content addition process 400 may comprise geocoding and/or reverse-geocoding a location associated with an element 404, such as a location associated with a group or channel. For example, a location may be geocoded and/or reverse-geocoded, or used in a geocoding and/or reverse-geocoding process, according to methods and/or processes described herein.

In some embodiments, an application and/or service, such as a mobile application/service, server application/service, cloud application/service, microservice, and/or web application may execute and/or include processes comprising determining a bounding region and/or generating a string or identifier representing a bounding region including a location. For example, location data and/or content addition process 400 may comprise determining a bounding region and/or generating a string or identifier representing a bounding region including a location associated with an element 406, such as a location associated with a group or channel.

In some embodiments, an application and/or service, such as a mobile application/service, server application/service, cloud application/service, microservice, and/or web application may execute and/or include processes comprising storing a location associated with a user entry, action, addition, and/or selection. For example, location data and/or content addition process 400 may comprise storing a location associated with an element 408, such as a received location 402 associated with a group or channel.

In some embodiments, an application and/or service, such as a mobile application/service, server application/service, cloud application/service, microservice, and/or web application may execute and/or include processes comprising storing a bounding region associated with a user entry, action, addition, and/or selection. For example, location data and/or content addition process 400 may comprise storing a bounding region associated with an element 410, such as a determined bounding region 406.

In some embodiments, an application and/or service, such as a mobile application/service, server application/service, cloud application/service, microservice, and/or web application may execute and/or include processes comprising storing location metadata associated with a user entry, action, addition, and/or selection. For example, location data and/or content addition process 400 may comprise storing location metadata associated with an element 412. In some embodiments, location metadata comprises any data determined and/or derived from a location. In some embodiments, location metadata comprises an address and/or part of an address. In some embodiments, location metadata comprises user activity associated with a location or during the addition of a group, channel, and/or location. In some embodiments, location metadata comprises date and/or time stamps/values. In some embodiments, location metadata comprises one or more session identifiers, such as a session identifier associated with a user during creation and/or addition of a group, channel, and/or location. In some embodiments, location metadata comprises user information associated with a user that is associated with creation and/or addition of a group, channel, and/or location. In some embodiments, location metadata comprises moderation data, such as results from a moderation service and/or microservice.

In some embodiments, an application and/or service, such as a mobile application/service, server application/service, cloud application/service, microservice, and/or web application may allow or cause copying, propagating, and/or storing stored data from one storage region, such as a first geographical region, into a second storage region, such as a second storage region. For example, location data and/or content addition process 400 may comprise copying and/or propagating stored data from a first storage region to an additional and/or alternate storage region 414.

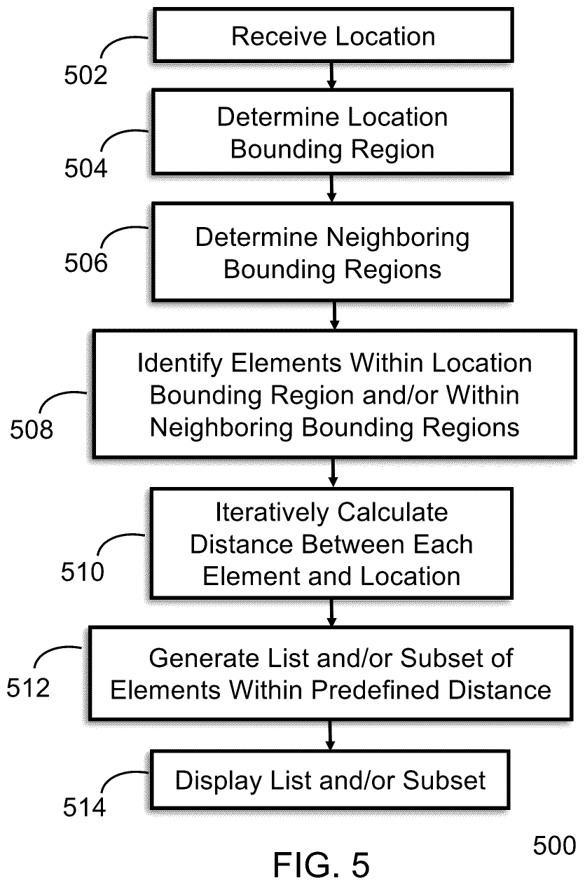

FIG. 5 is a flowchart showing a local and/or hyperlocal selection process 500 according to some embodiments.

In some embodiments, an application and/or service, such as a mobile application/service, server application/service, cloud application/service, microservice, and/or web application may execute and/or include processes comprising receiving a location associated with a user entry, action, addition, and/or selection. For example, local and/or hyperlocal selection process 500 may comprise receiving a location associated with an element 502, such as a location associated with a group or channel. In some embodiments, a location may be geocoded and/or reverse-geocoded, or used in a geocoding and/or reverse-geocoding process, according to methods and/or processes described herein.

In some embodiments, an application and/or service, such as a mobile application/service, server application/service, cloud application/service, microservice, and/or web application may execute and/or include processes comprising determining a bounding region and/or generating a string or identifier representing a bounding region including a location. For example, local and/or hyperlocal selection process 500 may comprise determining a bounding region and/or generating a string or identifier representing a bounding region including a location associated with an element 504, such as a location associated with a group or channel.

In some embodiments, an application and/or service, such as a mobile application/service, server application/service, cloud application/service, microservice, and/or web application may execute and/or include processes comprising determining one or more bounding regions neighboring a determined bounding region and/or generating strings or identifiers representing each of the neighboring bounding regions. For example, local and/or hyperlocal selection process 500 may comprise determining one or more bounding regions neighboring a determined bounding region 506, such determined bounding region 504, and/or generating strings or identifiers representing each of the neighboring bounding regions.

In some embodiments, an application and/or service, such as a mobile application/service, server application/service, cloud application/service, microservice, and/or web application may execute and/or include processes comprising determining one or more elements located within a determined bounding region and bounding regions neighboring a determined bounding region. For example, local and/or hyperlocal selection process 500 may comprise determining one or more elements located within a determined bounding region and bounding regions neighboring a determined bounding region, such as determined bounding region in 504 and determined neighboring bounding regions in 506.

In some examples, one or more data storage devices may store one or more elements, members, and/or data items. Each element, member, and/or data item may be stored in association with, or comprise, any combination or number of identifiers, names, strings, locations, addresses, coordinates, metadata, location metadata, and/or bounding region identifiers/strings. For example, one or more databases may store and/or comprise rows for each group in a set of one or more groups. One or more of the rows may comprise an identifier, a name, a location, latitude and/or longitude coordinates, and/or a bounding region string and/or identifier defining, identifying, and/or representing a bounding region which includes, encompasses, and/or surrounds the location. In some embodiments, bounding region strings/identifiers may be generated such that each additional character added to a first bounding region string produces another second bounding region string/identifier that defines, identifies, and/or represents a (second) bounding region within the first bounding region.

In some embodiments, an application and/or service, such as a mobile application/service, server application/service, cloud application/service, microservice, and/or web application may execute and/or include processes comprising identifying elements within one or more of the aforementioned bounding regions. For example, local and/or hyperlocal selection process 500 may comprise identifying elements located also within a received location's bounding region and/or located within one or more neighboring bounding regions 508.

In some embodiments, a rectangular bounding region is identified which includes, encompasses, and/or surrounds a received location. In at least some cases, a rectangular first bounding region may have one or more neighbors. For example, a rectangular first bounding region may have eight neighboring rectangular bounding regions (one neighbor for each side and one neighbor for each corner).

In some embodiments, a hexagonal bounding region is identified which includes, encompasses, and/or surrounds a received location. In at least some cases, a hexagonal first bounding region may have one or more neighbors. For example, a hexagonal first bounding region may have six neighboring hexagonal bounding regions (one neighbor for each side).

In some embodiments, a polygon bounding region is identified which includes, encompasses, and/or surrounds a received location. In at least some cases, a polygon first bounding region may have one or more neighbors.

In some examples, a first bounding region and its neighboring regions may serve as an initial region and/or set of regions for a data query and/or filter. For example, in some embodiments, a data set comprising groups located within any of the set of regions may be selected and/or queried from one or more data storage devices, such as one or more databases, to provide an first data set. In some cases, such a selection may be a one part of a local and/or hyperlocal selection process.

In some examples, a data set such as the aforementioned first data set may be further processed, reduced, trimmed, and/or filtered. In some embodiments, for example, each data member may be added to a list and/or other data structure. In some examples, a data member may comprise group data, such as a group name and latitude/longitude coordinates of a group location. One or more functions, methods, and/or processes may be used to iterate through a data member list and/or other data structure. For example, distance function and/or calculation can be carried out to compare a distance between each group represented and/or stored by each data member and a location 510, such as by using received location 502. A filtered and/or reduced data set/subset and/or data member list/data structure may be produced and/or generated 512.

In some embodiments, an application and/or service, such as a mobile application/service, server application/service, cloud application/service, microservice, and/or web application may execute and/or include processes comprising displaying a list and/or data subset. For example, local and/or hyperlocal selection process 500 may comprise displaying a list and/or data subset 514, such as for data members corresponding to data members in list/subset resulting in 512.

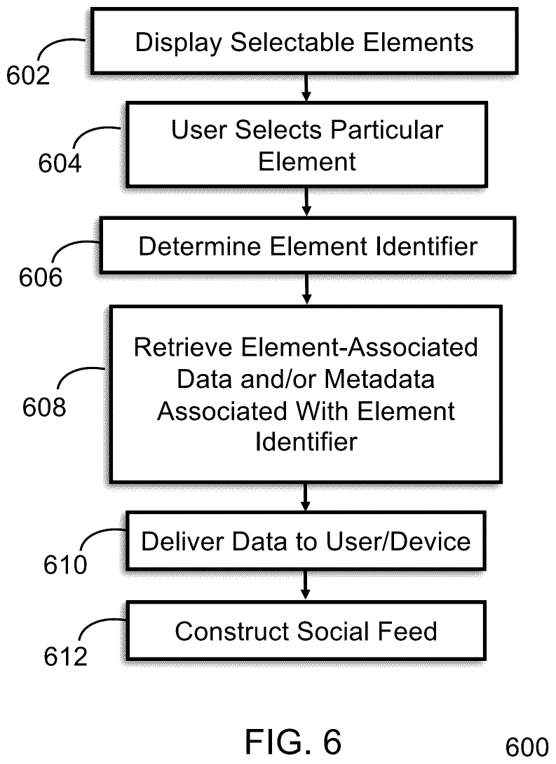

FIG. 6 is a flowchart showing a display process 600 according to some embodiments.

In some embodiments, an application and/or service, such as a mobile application/service, server application/service, cloud application/service, microservice, and/or web application may execute and/or include processes comprising displaying selectable elements. For example, display process 600 may comprise displaying a set of selectable elements 602. In some embodiments, selectable elements may be generated based on a list, data set, data structure, and/or data subset as described herein. For example, selectable elements may be generated based on a data set resulting from one or more of the query/filter processes described herein. In some embodiments, selectable elements comprise GUI elements, GUI elements with labels, GUI elements such as buttons, and/or GUI elements such as containers. In some embodiments, a selectable element is connected to one or more actions, methods, functions, and/or processes that are triggered when the element is selected. For example, one or more actions may be triggered when a selectable element is clicked.

In some embodiments, an application and/or service, such as a mobile application/service, server application/service, cloud application/service, microservice, and/or web application may execute and/or include processes comprising receiving a user selection of a selectable element. For example, display process 600 may comprise receiving a user selection of a selectable element 604. In some embodiments, upon a user selection, one or more actions, methods, functions, and/or processes may be triggered.

In some embodiments, an application and/or service, such as a mobile application/service, server application/service, cloud application/service, microservice, and/or web application may execute and/or include processes comprising determining an element identifier associated with a user-selected element. For example, display process 600 may comprise determining an element identifier associated with a user-selected element 606.

In some embodiments, an application and/or service, such as a mobile application/service, server application/service, cloud application/service, microservice, and/or web application may execute and/or include processes comprising retrieving element-associated data and/or metadata associated with an element identifier. For example, display process 600 may comprise retrieving element-associated data and/or metadata associated with an element identifier 608, such as element identifier determined in 606.

In some embodiments, an application and/or service, such as a mobile application/service, server application/service, cloud application/service, microservice, and/or web application may execute and/or include processes comprising delivering element-associated data and or metadata associated with an element identifier. For example, display process 600 may comprise delivering element-associated data and/or metadata associated with an element identifier to a user and/or user device 610.

In some embodiments, an application and/or service, such as a mobile application/service, server application/service, cloud application/service, microservice, and/or web application may execute and/or include processes comprising constructing a social feed. For example, display process 600 may comprise constructing a social feed based on element-associated data and/or metadata associated with an element identifier delivered to a user and/or user device 610.

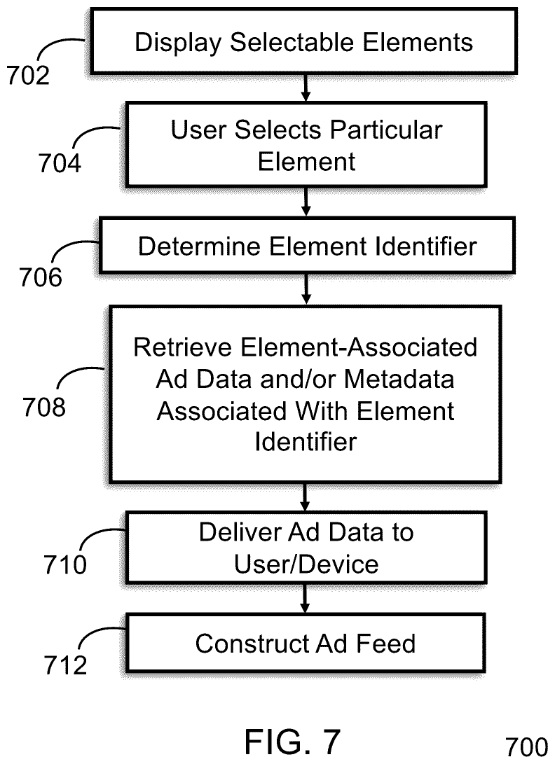

FIG. 7 is a flowchart showing a display process 700 according to some embodiments.

In some embodiments, an application and/or service, such as a mobile application/service, server application/service, cloud application/service, microservice, and/or web application may execute and/or include processes comprising displaying selectable elements. For example, display process 700 may comprise displaying a set of selectable elements 702. In some embodiments, selectable elements may be generated based on a list, data set, data structure, and/or data subset as described herein. For example, selectable elements may be generated based on a data set resulting from one or more of the query/filter processes described herein. In some embodiments, selectable elements comprise GUI elements, GUI elements with labels, GUI elements such as buttons, and/or GUI elements such as containers. In some embodiments, a selectable element is connected to one or more actions, methods, functions, and/or processes that are triggered when the element is selected. For example, one or more actions may be triggered when a selectable element is clicked.

In some embodiments, an application and/or service, such as a mobile application/service, server application/service, cloud application/service, microservice, and/or web application may execute and/or include processes comprising receiving a user selection of a selectable element. For example, display process 700 may comprise receiving a user selection of a selectable element 704. In some embodiments, upon a user selection, one or more actions, methods, functions, and/or processes may be triggered.

In some embodiments, an application and/or service, such as a mobile application/service, server application/service, cloud application/service, microservice, and/or web application may execute and/or include processes comprising determining an element identifier associated with a user-selected element. For example, display process 700 may comprise determining an element identifier associated with a user-selected element 706.

In some embodiments, an application and/or service, such as a mobile application/service, server application/service, cloud application/service, microservice, and/or web application may execute and/or include processes comprising retrieving element-associated data and/or metadata associated with an element identifier. For example, display process 700 may comprise retrieving element-associated data and/or metadata associated with an element identifier 708, such as element identifier determined in 706.

In some embodiments, an application and/or service, such as a mobile application/service, server application/service, cloud application/service, microservice, and/or web application may execute and/or include processes comprising delivering element-associated data and or metadata associated with an element identifier. For example, display process 700 may comprise delivering element-associated data and/or metadata associated with an element identifier to a user and/or user device 710.

In some embodiments, an application and/or service, such as a mobile application/service, server application/service, cloud application/service, microservice, and/or web application may execute and/or include processes comprising constructing a social feed. For example, display process 700 may comprise constructing a social feed based on element-associated data and/or metadata associated with an element identifier delivered to a user and/or user device 710.

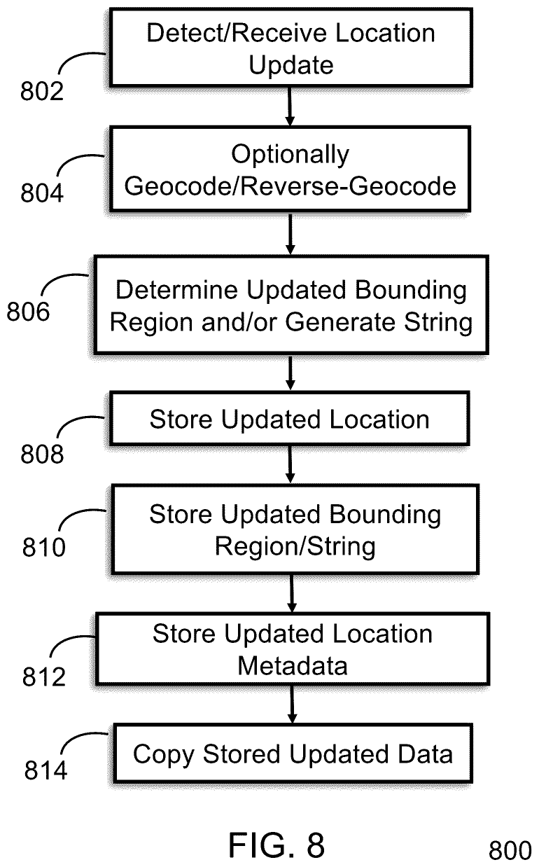

FIG. 8 is a flowchart showing an update process 800 according to some embodiments.

In some embodiments, an application and/or service, such as a mobile application/service, server application/service, cloud application/service, microservice, and/or web application may execute and/or include processes comprising receiving a location associated with a user entry, action, addition, and/or selection. For example, update process 800 may comprise receiving an updated location associated with an element 802, such as an updated location associated with a user, group, or channel.

In some embodiments, an application and/or service, such as a mobile application/service, server application/service, cloud application/service, microservice, and/or web application may execute and/or include processes comprising geocoding and/or reverse-geocoding an updated location associated with a user entry, action, addition, and/or selection. For example, update process 800 may comprise geocoding and/or reverse-geocoding an updated location associated with an element 804, such as an updated location associated with a user, group, or channel. For example, an updated location may be geocoded and/or reverse-geocoded, or used in a geocoding and/or reverse-geocoding process, according to methods and/or processes described herein.

In some embodiments, an application and/or service, such as a mobile application/service, server application/service, cloud application/service, microservice, and/or web application may execute and/or include processes comprising determining an updated bounding region and/or generating a string or identifier representing an updated bounding region including an updated location. For example, update process 800 may comprise determining a bounding region and/or generating a string or identifier representing a bounding region including an updated location associated with an element 806, such as a location associated with a user, group, or channel.

In some embodiments, an application and/or service, such as a mobile application/service, server application/service, cloud application/service, microservice, and/or web application may execute and/or include processes comprising storing a location associated with a user entry, action, addition, and/or selection. For example, update process 800 may comprise storing a location associated with an element 808, such as a received updated location 8402 associated with a user, group, or channel.

In some embodiments, an application and/or service, such as a mobile application/service, server application/service, cloud application/service, microservice, and/or web application may execute and/or include processes comprising storing a bounding region associated with a user entry, action, addition, and/or selection. For example, update process 800 may comprise storing an updated bounding region associated with an element 81o, such as a determined bounding region 806.

In some embodiments, an application and/or service, such as a mobile application/service, server application/service, cloud application/service, microservice, and/or web application may execute and/or include processes comprising storing updated location metadata associated with a user entry, action, addition, and/or selection. For example, update process 800 may comprise storing updated location metadata associated with an element 812. In some embodiments, updated location metadata comprises any data determined and/or derived from a location and/or updated location. In some embodiments, location metadata comprises an address and/or part of an address. In some embodiments, location metadata comprises user activity associated with a location or during the addition of a group, channel, and/or location. In some embodiments, location metadata comprises date and/or time stamps/values. In some embodiments, location metadata comprises one or more session identifiers, such as a session identifier associated with a user during creation and/or addition of a group, channel, and/or location. In some embodiments, location metadata comprises user information associated with a user that is associated with creation and/or addition of a group, channel, and/or location. In some embodiments, location metadata comprises moderation data, such as results from a moderation service and/or microservice.

In some embodiments, an application and/or service, such as a mobile application/service, server application/service, cloud application/service, microservice, and/or web application may allow or cause copying, propagating, and/or storing stored data from one storage region, such as a first geographical region, into a second storage region, such as a second storage region. For example, update process 800 may comprise copying and/or propagating stored data from a first storage region to an additional and/or alternate storage region 814.

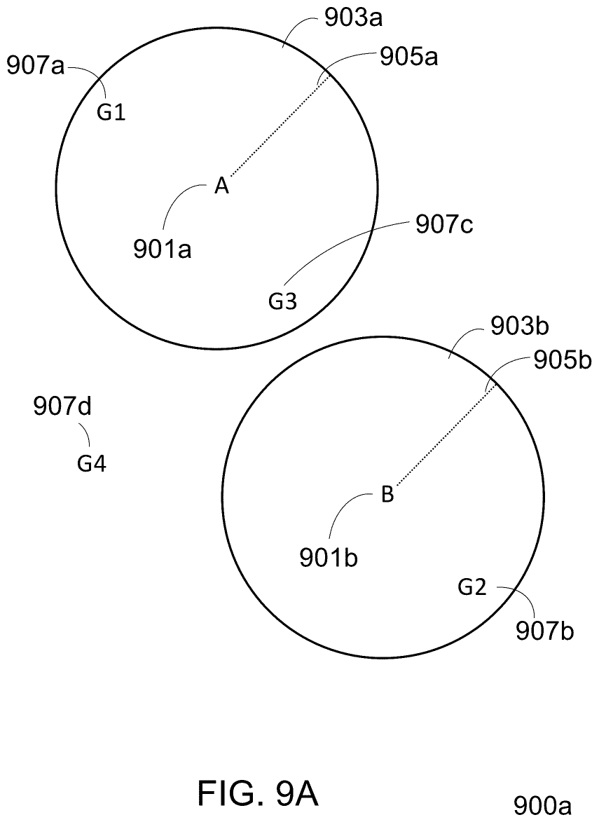

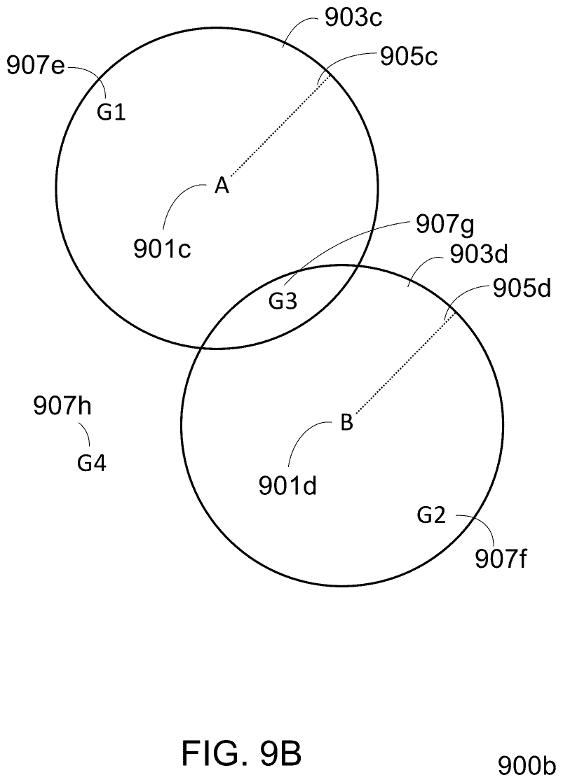

FIG. 9A is a diagram showing a first inclusion/exclusion example 900a according to some embodiments.

In some embodiments, a first set of users may be further apart than a predefined distance. In some embodiments, a first set of users may be further apart than twice the distance of a predefined distance. It will be understood that a predefined distance may be any distance selected and/or chosen. In some embodiments, a predefined distance may be selected, calculated, identified, determined, and/or chosen by a system, service, and/or software service provider. In some embodiments, a predefined distance may be selected and/or chosen by a system, service, and/or software service user such as an end user.

In one example 900a, a first user A (901a), a second user B (901b), groups G1 (907a), G2 (907b), G3 (907c), and G4 (907d) are shown, at positions and/or locations (such as geographic locations comprising latitude/longitude coordinates, etc.) relative to each other.

A first region comprising a first geographic region may be a first circular region 903a surrounding user A (901a), wherein the first circular region 903a may be defined by a first radius equal to a first distance and/or first predefined distance 905a and first center at a first user location corresponding to a first location of user A (901a) and/or a first user device associated with user A (901a). For example, a first user location and/or first device location may be a first latitude/longitude detected and/or determined at a first device associated with a first user.

Group G1 (907a) and group G3 (907c) are associated with locations, such as group locations, within the first circular region 903a.

Group G2 (907b) and group G4 (907d) are associated with locations, such as group locations, outside the first circular region 903a.

Accordingly, in some embodiments, a set of only groups within the first circular region 903a are included in a first subset of groups displayed to user A (G1 and G3 are included, and G2 and G4 are excluded), at a first time point when user A is detected and/or determined to be at the first user location and/or center of the first circular region 903a, described above.

A second region comprising a second geographic region may be a second circular region 903b surrounding user B (901b), wherein the second circular region 903b may be defined by a second radius equal to a second distance and/or second predefined distance 905b (which may be equal to the first distance and/or first predefined distance above, or different from the first distance and/or first predefined distance above) and second center at a second user location corresponding to a second location of user B (901b) and/or a second user device associated with user B (901b). For example, a second user location and/or second device location may be a second latitude/longitude detected and/or determined at a second device associated with a second user.

Group G1 (907a), group G3 (907c), and group G4 (907d) are associated with locations, such as group locations, outside the second circular region 903b.

Group G2 (907b) is associated with a location, such as a group location, inside the second circular region 903b.

Accordingly, in some embodiments, a set of only groups within the second circular region 903b are included in a second subset of groups displayed to user B (G2 is included, and G2, G3, and G4 are excluded), at a second time point (which may be the same or different from the aforementioned first time point) when user B is detected and/or determined to be at the second user location and/or center of the second circular region 903b, described above.

FIG. 9B is a diagram showing a second inclusion/exclusion example 900b according to some embodiments.

In some embodiments, a first set of users may be within a distance, such as a predefined distance, of each other. In some embodiments, a first set of users may be within a distance, such as twice a predefined distance, of each other. It will be understood that a predefined distance may be any distance selected and/or chosen. In some embodiments, a predefined distance may be selected, calculated, identified, determined, and/or chosen by a system, service, and/or software service provider. In some embodiments, a predefined distance may be selected, calculated, identified, determined, and/or chosen by a system, service, and/or software service user such as an end user.

In one example 900b, a first user A (901c), a second user B (901d), groups G1 (907e), G2 (907f), G3 (907g), and G4 (907h) are shown, at positions and/or locations (such as geographic locations comprising latitude/longitude coordinates, etc.) relative to each other.

A first region comprising a first geographic region may be a first circular region 903c surrounding user A (901c), wherein the first circular region 903c may be defined by a first radius equal to a first distance and/or first predefined distance 905c and first center at a first user location corresponding to a first location of user A (901c) and/or a first user device associated with user A (901c). For example, a first user location and/or first device location may be a first latitude/longitude detected and/or determined at a first device associated with a first user.

Group G1 (907f) and group G3 (907g) are associated with locations, such as group locations, within the first circular region 903c.

Group G2 (907f) and group G4 (907h) are associated with locations, such as group locations, outside the first circular region 903c.

Accordingly, in some embodiments, a set of only groups within the first circular region 903c are included in a first subset of groups displayed to user A (G1 and G3 are included, and G2 and G4 are excluded), at a first time point when user A is detected and/or determined to be at the first user location and/or center of the first circular region 903c, described above.

A second region comprising a second geographic region may be a second circular region 903d surrounding user B (901d), wherein the second circular region 903d may be defined by a second radius equal to a second distance and/or second predefined distance 905d (which may be equal to the first distance and/or first predefined distance above, or different from the first distance and/or first predefined distance above) and second center at a second user location corresponding to a second location of user B (901d) and/or a second user device associated with user B (901d). For example, a second user location and/or second device location may be a second latitude/longitude detected and/or determined at a second device associated with a second user.

Group G1 (907e) and group G4 (907d) are associated with locations, such as group locations, outside the second circular region 903d.

Group G2 (907b) and group G3 (907g) are associated with locations, such as a group location, inside the second circular region 903d.

Accordingly, in some embodiments, a set of only groups within the second circular region 903b are included in a second subset of groups displayed to user B (G2 and G3 are included, and G1 and G4 are excluded), at a second time point (which may be the same or different from the aforementioned first time point) when user B is detected and/or determined to be at the second user location and/or center of the second circular region 903b, described above.

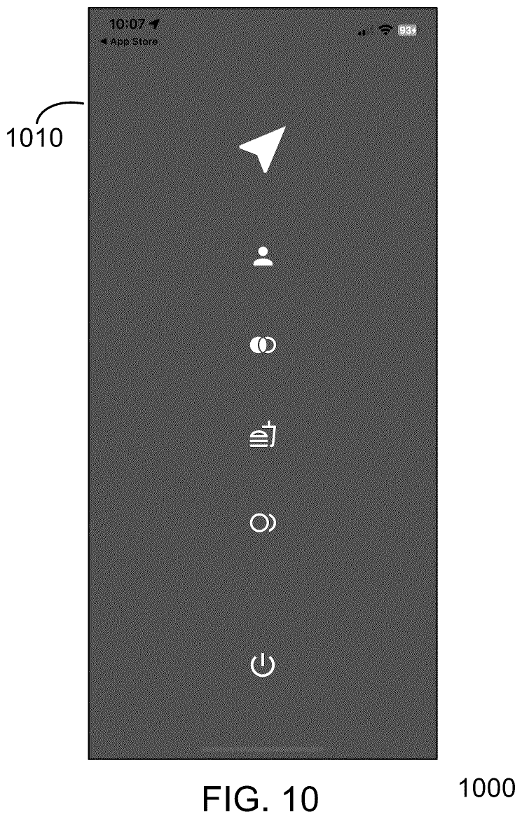

FIG. 10 is a diagram showing an example GUI example 1000, according to some embodiments.

In some embodiments, one or more graphical user interfaces (GUI)s 1010 may be provided and/or displayed to users to allow navigation to various other GUIs allowing access to various functions described herein.

For example, GUI 1010 is a mobile application page view showing several icons. Each icon may allow navigation to another GUI and/or mobile application page view upon a user selection. For example, a user selection may comprise a user gesture such as a click, tap, double-tap, swipe, etc.

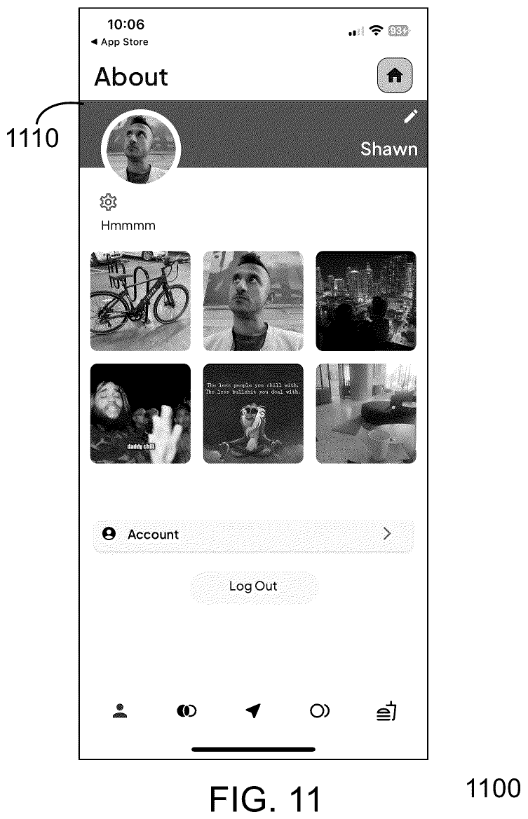

FIG. 11 is a diagram showing a GUI example 1100, according to some embodiments.

In some embodiments, one or more graphical user interfaces (GUIs) 1110 may be provided and/or displayed to users to allow access to a user profile belonging to himself and/or others, as described herein. For example, GUI 1110 is a mobile application page view showing a user profile. A user profile may comprise data about a user, such as images uploaded by the user, about/biography sections, links to the user's social media pages, and/or description sections.

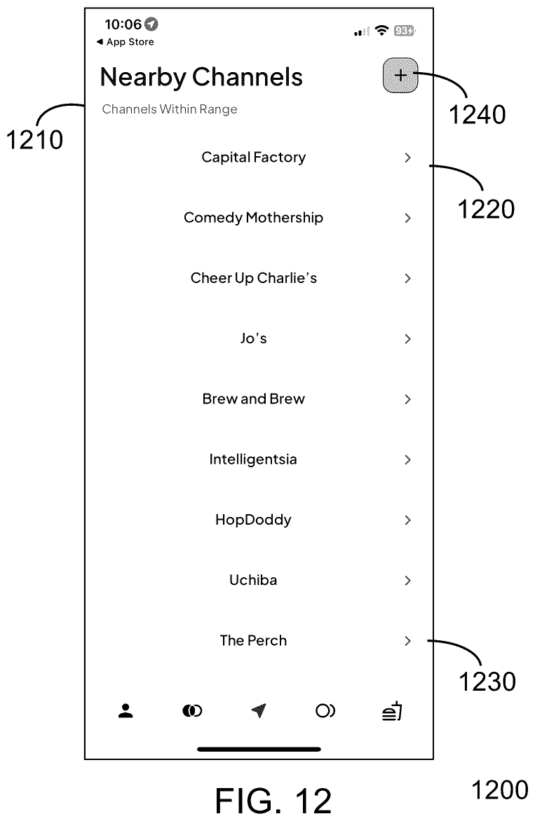

FIG. 12 is a diagram showing a GUI example 1200, according to some embodiments.

In some embodiments, one or more graphical user interfaces (GUIs) 1210 may be provided and/or displayed to users to allow access to, visualization of, and/or discovery of, nearby, local, and/or hyperlocal groups, as described herein. This is advantageous and/or more intuitive to users as it allows users to see/visualize some or all of their options at once and in relation to, for example, a distance they may be able to, or are willing to, travel, and additionally, may partially and/or fully restrict access to groups using a geographical barrier, limitation, and/or restriction. For example, users can simultaneously visualize nearby options while considering their own mental calculus regarding the group's distance and their willingness to travel at a current time. Further, for example, users are more likely to be able to interact with nearby users and/or users in common contexts when access to groups is limited to those nearby and/or reduce presence of group members that are less likely to be nearby, increasing the chance of facilitating real world interactions between users and/or creating interactions that may lead to real world interactions.

For example, GUI 1210 is a mobile application page view showing a set of nearby groups.

In some embodiments, a set of nearby groups may be displayed in a GUI view such as a list, map view (using, for example, icons at corresponding group locations on a map), etc.

A set of nearby groups may be identified and/or retrieved from a set of stored groups, as described herein.

In some embodiments, a listing of a set of nearby groups is shown wherein the group nearest to a user's location and/or user's device location may be displayed at the top of the list. The list may be ordered and/or re-ordered by increasing and/or decreasing distance from the user, by using calculated distances from the user's location and/or user's device location and locations associated with each group. For example, in GUI 1210, list element 1220 corresponding to group “Capital Factory” may be the group from the set of nearby groups that is currently closest to the user's current location and list element 1230 corresponding to group “The Perch” may be the group from the set of nearby groups that is currently farthest from the user's location. Distances from a user and/or user device location may be calculated as described herein.

In some embodiments, groups may be only discoverable and/or displayed to users within a predefined calculated distance of the group and/or only to users within a particular network and/or with associated permission/privileges to access the particular network, etc., as described herein. For example, a college student at the University of Texas at Austin (“UT”) is within a particular college network, UT, and more broadly, within a particular network, a college network. In some embodiments, users and/or group members may verify and/or be verified as within a particular network using, for example, a particular type of email address. For example an email address that includes and/or ends with a string such as “.edu” may be used to verify a user within a college network. In some embodiments, groups may be discoverable and/or displayed to all users.

In some embodiments, when a) a user's location and/or device location changes, b) movement is detected by a user's location and/or device location, c) a predefined time interval has elapsed, and/or d) upon a user's action and/or request to refresh the view, the set of nearby groups displayed to the user may, in response, be updated. This process may be partially and/or fully repeated continuously and/or automatically. For example, a user may make a gesture (such as pulling down on a list view of nearby groups) to refresh and/or update the list of displayed nearby groups using the user's most up-to-date location and/or ordered by the most up-to-date distance determinations. Some or all of distance calculation processes (such as between user/user device and a subset of groups), as described herein, may be repeated and/or re-executed to determine and/or update a subset of groups currently within a predefined distance from the user's location. In another example, the list of displayed nearby groups using the user's most up-to-date location and/or ordered by the most up-to-date distance determinations may be updated automatically and/or without user action. Some or all of the aforementioned processes may be carried out and/or executed locally on the user's device, at an edge or proxy location, a cloud location, and/or at a remote location. In some embodiments, a large subset of groups and/or groups data may be cached on a user's device and/or used to perform distance calculations locally on the user's device as the user's location and/or device location changes, reducing the need for network requests, etc. The aforementioned processes provide an intuitive, efficient, quickly-consumable, advantageous, and/or granular user experience similar to physical exploration of nearby locations including discovery of new groups when a user moves into the new groups' vicinities.

In one example, a subset of groups data from a set of stored groups data may be retrieved, cached, and/or downloaded by a network request to a user's device. The subset of groups data may comprise groups data for groups corresponding to group locations within a particular region surrounding the user's location and/or user device location. For example, a particular geohash region may be determined which contains the user's location and/or user device location, and the geohash regions neighboring the particular geohash region may be determined. The particular region surrounding the user's location and or user device location may then be defined by the region comprising some or all of the particular geohash region and/or geohash regions neighboring the particular geohash region. After the subset of groups data has been retrieved, cached, and/or downloaded to the user's device, additional network requests may be avoided for a particular amount of time and/or for a particular threshold of user movement. The distance between the user and each of the retrieved, cached, and/or downloaded groups may be continuously determined, redetermined, calculated, recalculated, adjusted and/or readjusted locally on a user's device, for example. In some examples, a network request for a subset of groups data from a set of stored groups data to be retrieved, cached, and/or downloaded to the user's device may be triggered by a particular event and/or indicator, such as an indicator of stale and/or outdated groups data, or any indicator that the user′ has exited the region defined by the particular geohash region.

In some embodiments, user's may be allowed and/or permitted to select and/or interact with GUI elements, such as each list item. For example, selection of list element 1220 may cause navigation to another GUI mobile application page view similar to GUI 1410, but corresponding to the group “Capital Factory” and its associated group data rather than the group “Sparq on Rio.”

In some embodiments, user's may be allowed and/or permitted to create and/or add new groups using one or more GUI elements, such as an add button 1240. For example, selection of add button 1240 may cause navigation to another GUI mobile application page view such as 1310.

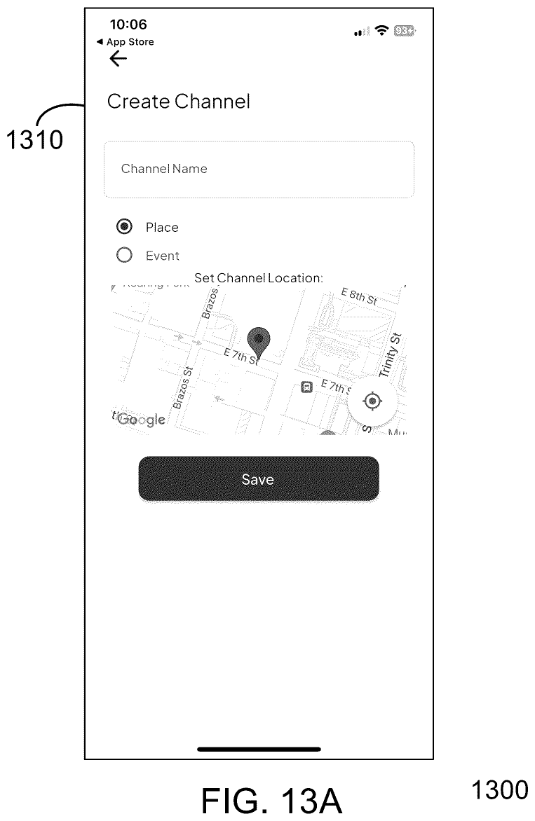

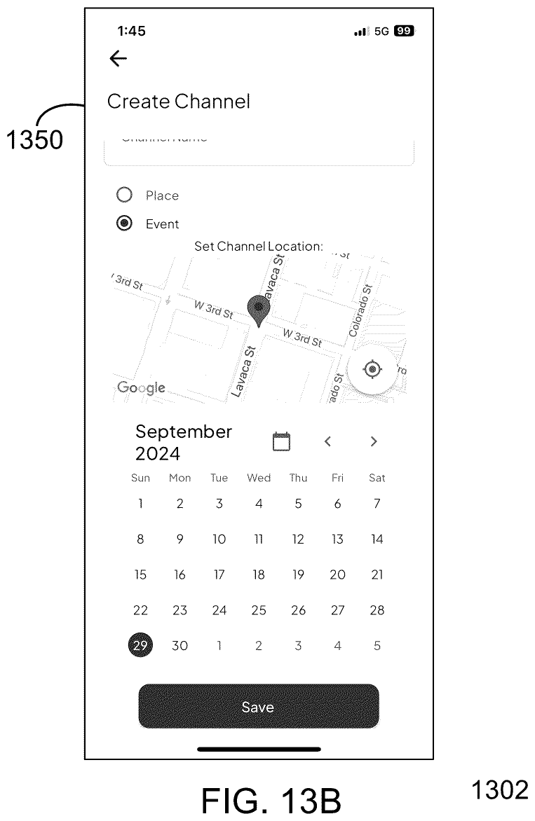

FIG. 13A is a diagram showing a GUI example 1300, according to some embodiments.

In some embodiments, one or more graphical user interfaces (GUIs) 1310 may be provided and/or displayed to users to allow creation and/or addition of new groups, as described herein.

For example, GUI 1310 is a mobile application page view allowing creation and/or addition of a new group.

During the addition of a new group, the user may be allowed to enter information associated with the group, such as a name and/or location. For example, a user may be allowed to select and/or enter an address and/or drop a pin on a map interface. In some embodiments, a latitude and/or longitude may be identified as associated with and/or corresponding to the user-selected location, as described herein. For example, a latitude and/or longitude may be determined by one or more geocoding and/or reverse-geocoding processes, including determining a corresponding geohash, as described herein. The latitude and/or longitude may be stored, as the group's corresponding location, in association with the group name, geohash, geocoded/reverse-geocoded data, and/or group identifier, such as a unique group identifier comprising a string that is newly assigned and/or created.

FIG. 13B is a diagram showing a GUI example 1302, according to some embodiments.

In some embodiments, one or more graphical user interfaces (GUIs) 1350 may be provided and/or displayed to users to allow creation and/or addition of new groups comprising groups for events, as described herein.

For example, GUI 1350 is a mobile application page view allowing creation and/or addition of a new group comprising a group for an event.

During the addition of a new group comprising a group for an event, the user may be allowed to enter information (in addition to the information described above in the description of FIG. 13A) associated with the group, such as a date and/or time or date and/or time range during which the event occurs or will occur. For example, a user may be allowed to enter a start date and/or time and an end date and/or time corresponding to an event. In some embodiments, the user may be allowed to enter information as previously described, such as a location corresponding to the event.

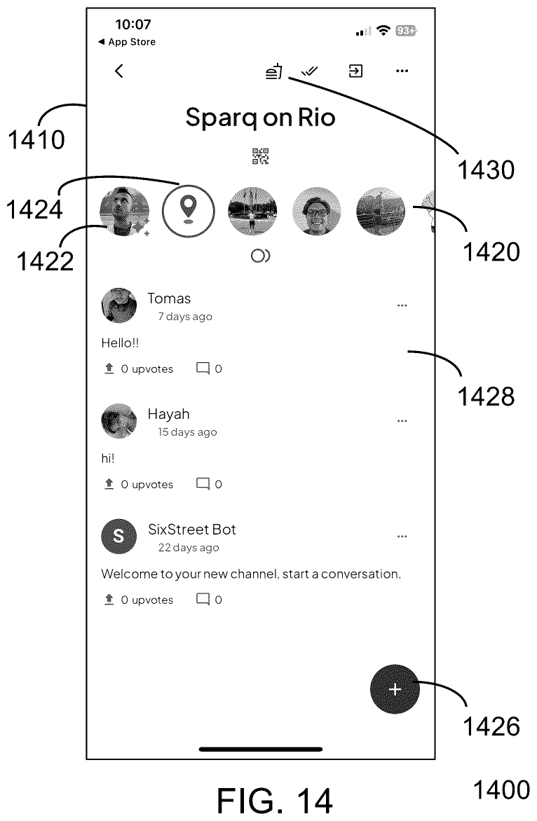

FIG. 14 is a diagram showing a GUI example 1400, according to some embodiments.

In some embodiments, one or more graphical user interfaces (GUIs) 1410 may be generated, provided, presented, and/or displayed to users to allow interaction with groups and/or applications, as described herein.

For example, GUI 1410 is a mobile application page view allowing a user to view, interact with, and/or consume group information, group data, and/or group members.

Example GUI 1410 shows information/data associated with a group named “Sparq on Rio.”

The information/data of GUI 1410 comprises a set of group members 1420 including some or all users that have joined the group “Sparq on Rio” (ie., group members). A profile picture of each group member of the set of group members 1420 comprises a circular group member image. Selection of a particular group member image may cause navigation to another page, such as a profile page associated with and/or belonging to the selected user.

In some embodiments, a GUI element 1422 associated with the user may be displayed on GUI 1410. It will be understood that a GUI element may comprise any GUI element, such as an image, text, icon, button, container, etc. In some embodiments, a user interaction, such as a user gesture, click, tap, double-tap, etc., with GUI element 1422 may cause display and/or navigation to one or more pages and/or GUIs to allow the user to upload and/or create a story, for example. For example, a camera and/or local storage selection option may be displayed allowing a user to take a new image and/or video, and/or upload an image and/or video from local device storage or other storage device, such as cloud storage device/location.

In some embodiments, stories and/or content (such as posts, comments, replies, images, videos, advertisements, deals, offers, etc) created and/or uploaded by a group's members from a corresponding group page may be automatically associated with a corresponding unique group identifier and/or group data. Accordingly, group members may be allowed to target content and/or stories to selected groups and, in turn, target geographic locations that are associated with the selected groups (because, for example, each selected group may be associated with a group location) and/or, in turn, particular dates and/or times that are associated with the selected groups, such as event groups (because, for example, each selected event group may be associated with a date and/or time associated with the event). Therefore, this disclosure teaches that group members may classify, categorize, target, contextualize, hyper-contextualize, associate, tether, attach, connect, synchronize, and/or direct stories (solo-author and/or shared-author) and/or content to, or into, a particular, selected and/or chosen set of groups, particular geographical locations and/or regions, and/or particular date/date range/time/time range/time period. Contextualization and/or hyper-contextualization, as disclosed, provides numerous advantages including providing more relevant, intuitive, and/or interesting information to users and/or group members, encouraging and/or allowing discovery of real-world experiences and/or ideas from others with things in common, such as common group membership, common geographical location and/or spaces contexts, and/or common date and/or time contexts. Current systems do not exist that provide or allow the disclosed efficient space-time context discovery, for example. For example, current systems do not allow users to efficiently search for, or discover, stories and/or content, such as ephemeral content, aggregated from groups/group members based on locations and/or time contexts.

In some embodiments, a GUI element 1424 associated with a set and/or collection of stories associated with the group corresponding to the group page (“Sparq on Rio,” in this example) may be displayed. In some embodiments, a user interaction, such as a user gesture, click, tap, double-tap, etc., with GUI element 1424 may cause and/or initiate display of one or more of the set and/or collection of stories associated with the group corresponding to the group page. In some embodiments, a user interaction, such as a user gesture, click, tap, double-tap, etc., with GUI element 1424 may cause and/or initiate display of a sequence of stories comprising the set and/or collection of stories associated with the group corresponding to the group page. The set and/or collection of stories may be aggregated from stories that have been posted by group members while visiting the group page, for example. In other words, group stories may be crowdsourced from group members. Thus, crowdsourced group stories may be hyper-localized and/or hyper-contextualized by to embodiments herein.

In some embodiments, a GUI element 1426 may be displayed to allow group members to create posts 1428 on a group page. In some embodiments, after a user creates a post on a group page, other group members may be notified. For example, group members may receive a push notification, SMS notification, and/or email notification comprising a message that a post was made, the content of the post, the name of the group in which the post was made, and/or the name of the user that created the post. In some embodiments, group members may be allowed to mute, opt in/out, and/or turn on/off some or all of the aforementioned notifications.

In some embodiments, creation of a post may include one or more biometric authentication steps, which may serve to exclude artificially and/or programmatically generated content (such as content generated by artificial intelligence). For example, in some embodiments, a user's identity may be verified by a fingerprint, eye/retina scan, etc., before allowing posting of content. In some embodiments, a user's identity verification may be valid for a predetermined period of time using and/or storing, for example, a token, session, and/or cache variable and/or expiration.

In some embodiments, a GUI element 1430 may be displayed to allow group members to view advertisements, deals, and/or offers associated with the group and/or targeted to the group. Thus, advertisements, deals, and/or offers may be hyper-localized and/or hyper-contextualized by to embodiments herein.

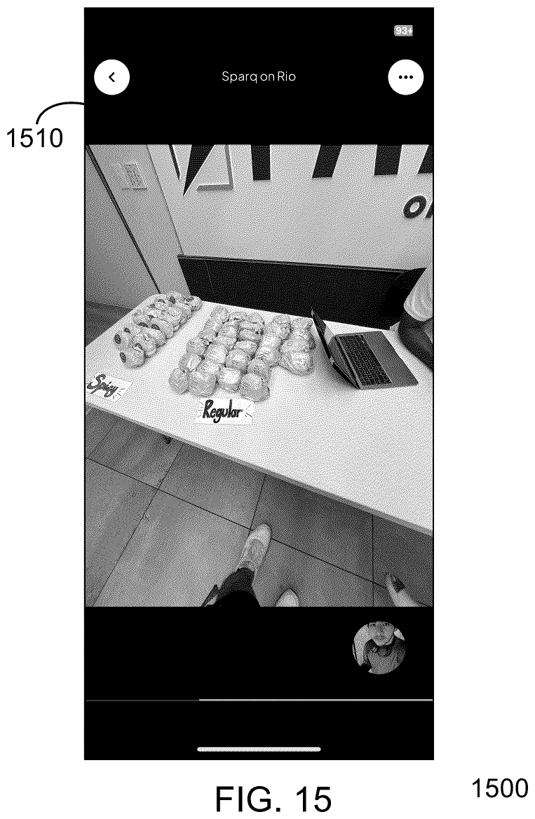

FIG. 15 is a diagram showing a GUI example 1500, according to some embodiments.

In some embodiments, one or more graphical user interfaces (GUIs) 1510 may be generated, provided, presented, and/or displayed to users to allow interaction with content associated with groups, such as allowing a user to view, interact with, and/or consume group stories, as described herein.

For example, GUI 1510 is a mobile application page view showing a first solo-author group story by a first group member.

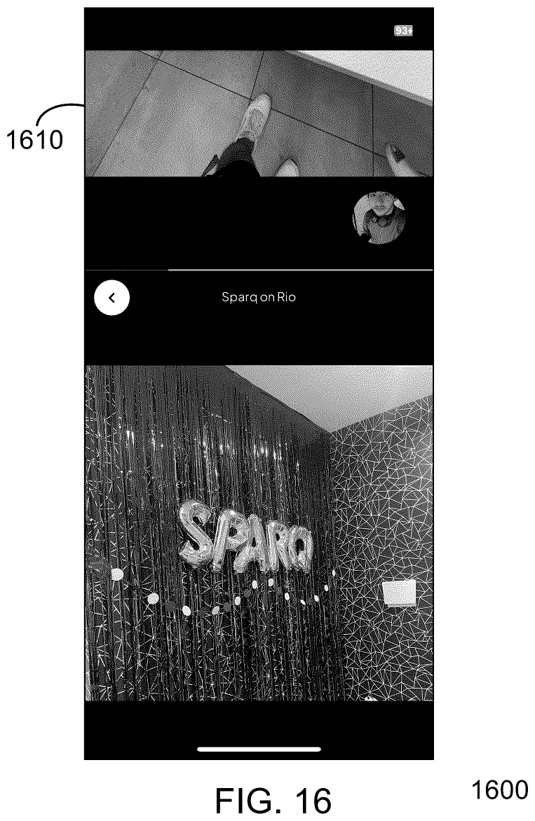

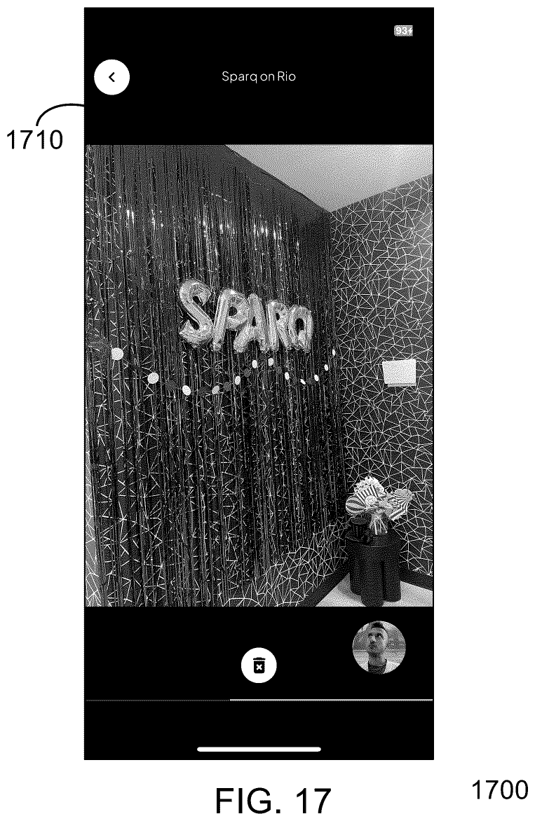

In some embodiments, while a story is being displayed and/or presented, a subsequent set of stories may be preloaded, allowing for a smoother user experience. For example, a next solo-author story, such as the story shown in FIGS. 16 and 17 may be preloaded during the display of the first solo-author story.

In some embodiments, a set of content items may be retrieved by a set of batch requests and/or via a set of parallel requests, which may reduce network requests and/or roundtrips to a server, for example.

In this example, a first group story is displayed, and, upon expiration of a timer of predefined duration, a next group story in a sequence is similarly, automatically displayed with a timer of predefined duration. In some embodiments, the viewing user may be allowed to proceed to a next group story in a sequence before the timer expires, using a gesture, such as a swipe gesture, for example. For example, a user may be able to swipe up to view a next group story.

FIG. 16 is a diagram showing a GUI example 1600, according to some embodiments.

In some embodiments, one or more graphical user interfaces (GUIs) 1610 may be generated, provided, presented, and/or displayed to users to allow interaction with content associated with groups, as described herein.

For example, GUI 1610 is a mobile application page view showing a transition state when a user swipes up to a next solo-author group story by a second group member different from the first group member shown in FIG. 15.

FIG. 17 is a diagram showing a GUI example 1700, according to some embodiments.

In some embodiments, one or more graphical user interfaces (GUIs) 1710 may be generated, provided, presented, and/or displayed to users to allow interaction with content associated with groups, as described herein.

For example, GUI 1710 is a mobile application page view showing a next solo-author group story (by a second group member different from the first group member shown in FIG. 15) after a user swipes up on an earlier group story in a sequence.

In some embodiments, while the story is being displayed and/or presented, a subsequent set of stories may be preloaded, allowing for a smoother user experience. For example, a next solo-author story may be preloaded during the display of the first solo-author story.

In this example, the group story is displayed, and, upon expiration of a timer of predefined duration, a next group story in a sequence is similarly, automatically displayed with a timer of predefined duration. In some embodiments, the viewing user may be allowed to proceed to a next group story in a sequence before the timer expires, using a gesture, such as a swipe gesture, for example. For example, a user may be able to swipe up to again view a next group story.

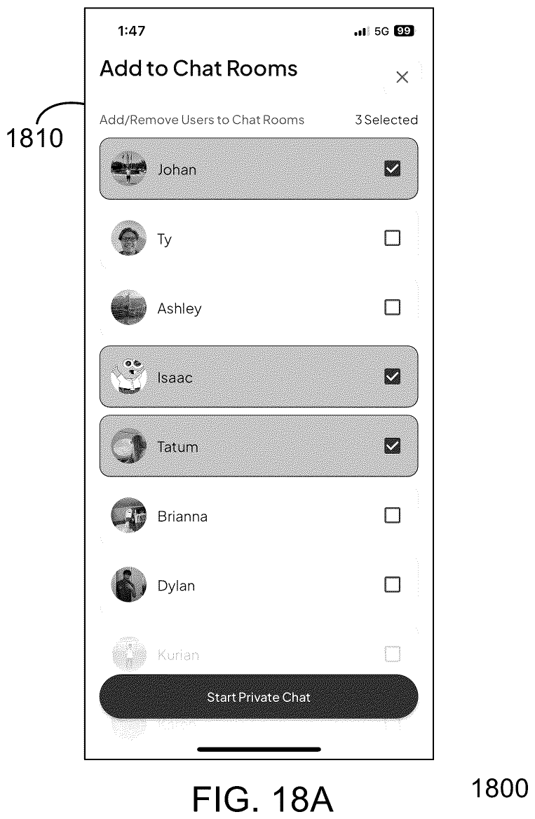

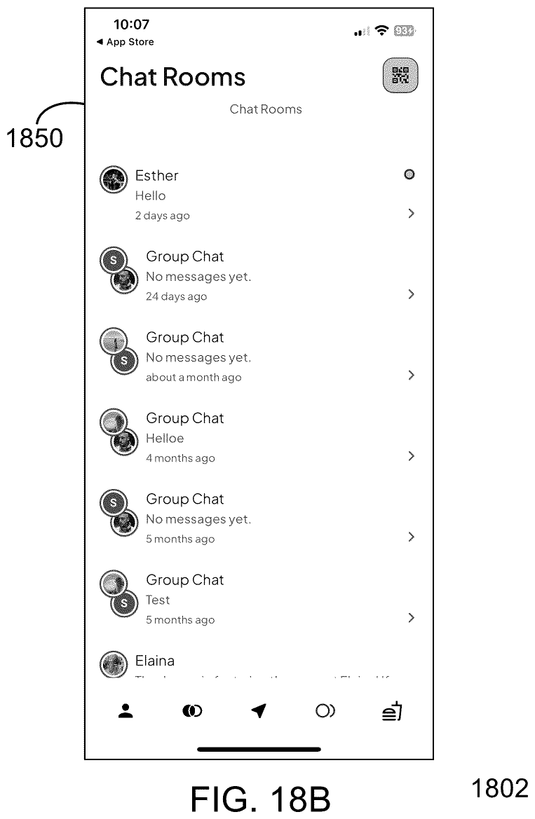

FIG. 18A is a diagram showing a GUI example 1800, according to some embodiments.

In some embodiments, one or more graphical user interfaces (GUIs) 1810 may be generated, provided, presented, and/or displayed to users to allow interaction with group members, as described herein.

For example, GUI 1810 is a mobile application page view showing a group member selection interface, which allows a group member to select other group members to add to a private chat group.

FIG. 18B is a diagram showing a GUI example 1802, according to some embodiments.

In some embodiments, one or more graphical user interfaces (GUIs) 1850 may be generated, provided, presented, and/or displayed to users to allow interaction with group members, as described herein.

For example, GUI 1850 is a mobile application page view showing a group chat interface, which allows a group member to view and/or manage private chat groups in which the group member is included.

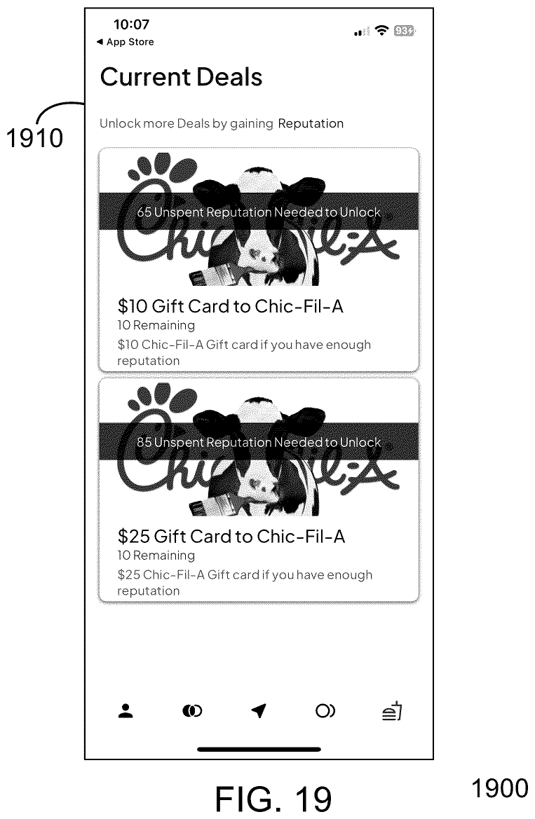

FIG. 19 is a diagram showing a GUI example 1900, according to some embodiments.

In some embodiments, one or more graphical user interfaces (GUIs) 1910 may be generated, provided, presented, and/or displayed to users to allow interaction and/or access to deals and/or offers, such as deals associated with, and/or targeted to, groups, as described herein.

For example, GUI 1910 is a mobile application page view showing a deals and/or offers interface, which allows a group member to view deals and/or offers targeted/directed to particular groups, as described herein. In this way, similar to group data and associated information described herein, deals, offers, and/or offers may also be contextualized, localized, and/or hyper-localized. This allows, for example, merchants and/or advertisers to target groups that are highly relevant and/or more likely to make a purchase and/or redemption. In other words, advertisements, offers, and/or deals may inherit context from group contexts as described herein.

In some embodiments, space for advertising based on ranking position may be made available for purchase. For example, a top space for an advertisement targeted to a particularly relevant group to an advertiser may be made available for purchase. In some embodiments, a pricing model may be dynamically determined based on demand and/or by bidding for spaces and/or positions. In some embodiments, a console, such as a merchant console as described herein, may be provided to allow merchants and/or advertisers to bid and/or purchase particular ad spaces. For example, a merchant console may allow a restaurant merchant to view/visualize (such as in a list and/or map view) groups nearby and/or surrounding his restaurant and the price to place ads in each of those particular groups and in each ranking space for those groups. The merchant may then be able to bid and/or purchase an ad space and/or create an ad for that space. In some embodiments, ads may be automatically created and/or include content provided/uploaded by a merchant. For example, a merchant may upload text, image, and/or video content. In some embodiments, merchant content may be screened and/or forward to a service and/or microservice, such as an artificial intelligence and/or content moderation service as described herein. In another example, an apartment building merchant may be able to direct and/or target ads or offers to groups for other apartment buildings, ephemeral events (ex., such as a housing fair), and/or dorms nearby, which include group members that may be more likely to be interested in the targeted ads or offers.

In some embodiments, one or more GUI elements may be accessible from a group page which allow access to deals, offers, and/or advertisements targeted to the group. In some cases, a GUI element, such as a “Redeem” button, may be presented on a particular deal and/or offer page or view, allowing purchase and/or redemption of the deal and/or offer, for example.

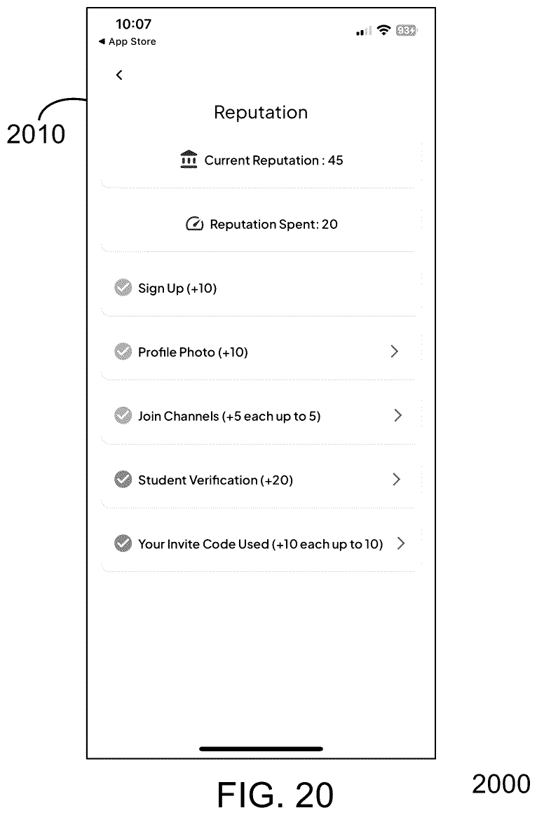

FIG. 20 is a diagram showing a GUI example 2000, according to some embodiments.

In some embodiments, one or more graphical user interfaces (GUIs) 2010 may be generated, provided, presented, and/or displayed to users to allow interaction with user reputation, as described herein.

For example, GUI 2010 is a mobile application page view showing a reputation interface. In some embodiments, a user's reputation and/or unspent/unused reputation may allow access to particular deals and/or offers associated with a minimum reputation requirement. In some embodiments, users may gain reputation through various engagement activities and/or by purchase, for example.

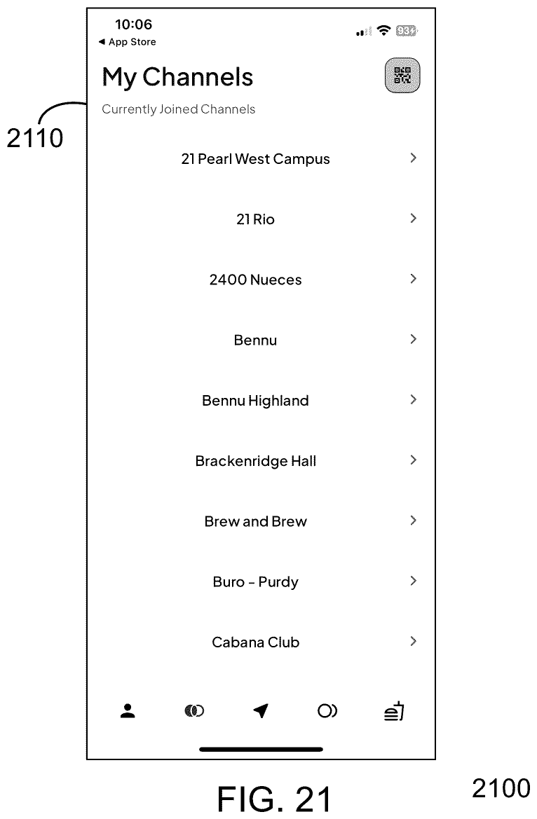

FIG. 21 is a diagram showing a GUI example 2100, according to some embodiments.

In some embodiments, one or more graphical user interfaces (GUIs) 2110 may be generated, provided, presented, and/or displayed to users to allow interaction with groups and/or applications in which a user is a group member, as described herein.

For example, GUI 2110 is a mobile application page view showing a groups interface showing a listing of groups and/or channels in which the user is a member. In some embodiments, users may select a list item to navigate to a group page, as described herein.

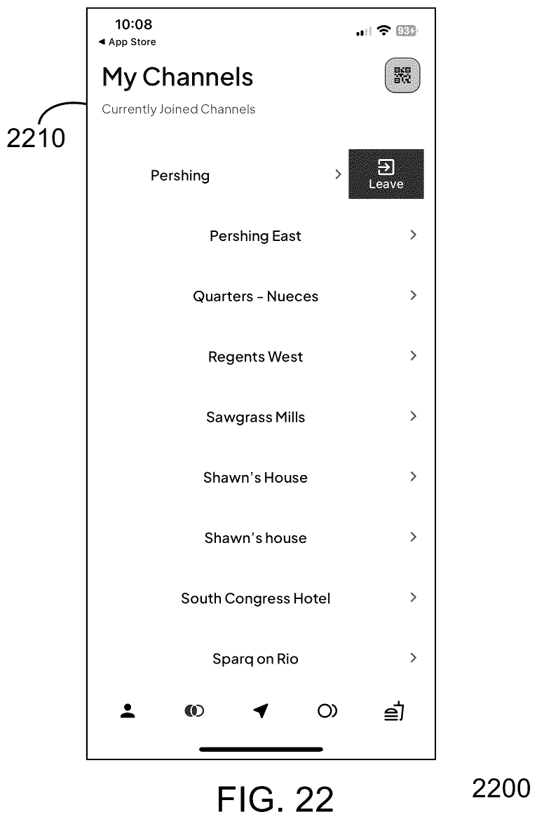

FIG. 22 is a diagram showing a GUI example 2200, according to some embodiments.

In some embodiments, one or more graphical user interfaces (GUIs) 2210 may be generated, provided, presented, and/or displayed to users to allow interaction with groups and/or applications in which a user is a group member, as described herein.

For example, GUI 2210 is a mobile application page view showing a groups interface showing a listing of groups and/or channels in which the user is a member. In some embodiments, users may be able to interact with a list item, such as by swiping to reveal an action button, to leave a group, as described herein.

### Advantages

Numerous advantages are gained by the embodiments described herein. In some examples, providing information on a basis of user location acts as a barrier to accessing and/or abuse of content from outsiders from an area.

In some example embodiments, after a user is authenticated, various selectable options may be displayed and/or presented in one or more GUIs and/or pages. Selectable options may be displayed as buttons, icons, and/or menu or list options, for example. Selectable options may be selected by a user. Selection of an option may cause navigation to another GUI and/or page.

In some embodiments, selectable options may include a button to view a page that displays a list or set of nearby groups, events, channels

### Additional Example Embodiments are Provided Below

### Embodiment 1

A method comprising:
providing a mobile or web application;
allowing a user registration;
creating a first user account for a first user, by a software service provider, wherein creating the first user account comprises:
   creating, by the software service provider, a first user account identifier for the first user;
   storing, by the software service provider, in association with the first user account, the first user account identifier in the one or more databases and/or data storage devices;
   associating, by the software service provider, login credentials with the first user; and
   storing, by the software service provider, the login credentials in the one or more data storage devices;
receiving an authentication request to access the first user account, wherein:
   the authentication request is received via a first HTTP/HTTPS request, the first HTTP/HTTPS request including the login credentials;
authenticating the authentication request, wherein the authenticating comprises:
   verifying the login credentials;
in response to the authenticating, allowing access to a first user account portal allowing selections or updates;
requesting/delivering a first location to a user device, wherein the first location comprises a default location or a last known location of the user;
   wherein the first location comprises GPS coordinates, the GPS coordinates comprising a latitude, longitude, and/or altitude;
using the first location as a default location;
requesting/ascertaining a current user location using an asynchronous or synchronous method or function to access a user device location;
updating the first location and the last known location of the user using the current user location; displaying a list of elements selected from a stored list based on the first location, wherein the list of elements comprise one or more groups;
wherein displaying the list of elements selected from a stored list based on the first location comprises determining a distance between the first location each of one or more elements in the stored list;
wherein determining a distance between the first location each of one or more elements in the stored list comprises:
   executing a course query to determine a bounding box around the first location;
   executing a fine query using the first location, the fine query comprising applying a spatial convenience function;
providing results to the mobile application, the results formatted as a set of JSON objects; and
allowing the first user to access and/or join one or more of the one or more groups.

### Embodiment 2

A system configured to perform the above method of Embodiment 1.

### Embodiment 3

One or more computer readable media storing instructions to execute the above method of Embodiment 1.

### Embodiment 4

A method comprising:
providing a mobile or web application;
allowing a user registration;
creating a first user account for a first user, by a software service provider, wherein creating the first user account comprises:
   creating, by the software service provider, a first user account identifier for the first user;
   storing, by the software service provider, in association with the first user account, the first user account identifier in the one or more databases and/or data storage devices;
   associating, by the software service provider, login credentials with the first user; and
   storing, by the software service provider, the login credentials in the one or more data storage devices;
receiving an authentication request to access the first user account, wherein:
   the authentication request is received via a first HTTP/HTTPS request, the first HTTP/HTTPS request including the login credentials;
authenticating the authentication request, wherein the authenticating comprises:
   verifying the login credentials;
in response to the authenticating, allowing access to a first user account portal allowing selections or updates;
requesting/delivering a first location to a user device, wherein the first location comprises a default location or a last known location of the user;
   wherein the first location comprises GPS coordinates, the GPS coordinates comprising a latitude, longitude, and/or altitude;
using the first location as a default location;
requesting/ascertaining a current user location using an asynchronous or synchronous method or function to access a user device location;
updating the first location and the last known location of the user using the current user location; storing the first location in one or more data storage devices;
determining or calculating a first geohash corresponding to the first location;
storing the first geohash in association with the first user;
displaying a list of elements selected from first stored data based on the first location;
   wherein the first stored data comprises:
      one or more locations, events, or groups;
      wherein each of the one or more locations, events, or groups is associated with a respective stored geohash;
wherein displaying a list of elements selected from the first stored data based on the first location comprises determining distances between the one or more locations, events, or groups and the first location;
wherein determining the distances between the one or more locations, events, or groups and the first location comprises:
determining a set of geohashes neighboring the first geohash, wherein the set of geohashes comprises eight geohashes including:
   a northern neighbor of the first geohash;
   a southern neighbor of the first geohash;
   an eastern neighbor of the first geohash;
   a western neighbor of the first geohash;
   a northwestern neighbor of the first geohash;
   a northeastern neighbor of the first geohash;
   a southwestern neighbor of the first geohash;
   a southeastern neighbor of the first geohash;
   executing one or more queries to retrieve data elements corresponding to one or more locations, events, or groups within locations bounded by at least one of the set of geohashes;
   executing a fine query using the first location, the fine query comprising a spatial convenience function;
providing results to the mobile application, the results formatted as a set of JSON objects;
allowing the first user to access and/or join one or more of the one or more locations, events, or groups.

### Embodiment 5

A system configured to perform the above method of Embodiment 4.

### Embodiment 6

One or more computer readable media storing instructions to execute the above method of Embodiment 4.

### Embodiment 7

A method comprising:
providing a mobile or web application to a user device;
allowing a first user to register;
creating a first user account for the first user, by a software service provider, wherein creating the first user account comprises:
   creating, by the software service provider, a first user account identifier for the first user;
   storing, by the software service provider, in association with the first user account, the first user account identifier in the one or more databases and/or data storage devices;
   associating, by the software service provider, login credentials with the first user; and
   storing, by the software service provider, the login credentials in the one or more data storage devices;
receiving an authentication request to access the first user account, wherein:
   the authentication request is received via a first HTTP/HTTPS request, the first HTTP/HTTPS request including the login credentials;
authenticating the authentication request, wherein the authenticating comprises:
   verifying the login credentials;
in response to the authenticating, allowing access to a first user account;
requesting/ascertaining a first location corresponding to a current user location of the user device using an asynchronous or synchronous method or function;
updating a last known location of the user using the first location;
displaying a list of elements based on the first location,
   wherein each of the elements comprises a group corresponding to a particular place or event, and wherein each of the elements is associated with a particular location;
wherein the list of elements are selected from a stored list based on the first location by determining one or more elements in the stored list that are within a particular distance from the first location;
wherein determining one or more elements in the stored list that are within a particular distance from the first location comprises:
   executing a query using the first location, the fine query comprising applying a spatial convenience function;
providing results to the mobile or web application;
displaying the results on the user device using the mobile or web application;
allowing the first user to create a new group;
associating the new group with the first location;
storing a new list element corresponding to the new group in association with the first location;
wherein each of the list of elements is a selectable element linking to a respective group page;
wherein each respective group page comprises a message board, chat room, and/or pages or allowing one or more group members to interact;
wherein each group page displays a list of group members comprising icons, graphical elements, and/or textual elements;
wherein each of the list of group members is a selectable element linking to a respective group member profile;
   wherein each profile comprises:
      a direct message link;
      one or more social media profile links.

### Embodiment 8

A system configured to perform the above method of Embodiment 7.

### Embodiment 9

One or more computer readable media storing instructions to execute the above method of Embodiment 7.

### Embodiment 10

A method comprising:
providing a mobile or web application to a user device;
allowing a first user to register;
creating a first user account for the first user, by a software service provider, wherein creating the first user account comprises:
   creating, by the software service provider, a first user account identifier for the first user;
   storing, by the software service provider, in association with the first user account, the first user account identifier in the one or more databases and/or data storage devices;
   associating, by the software service provider, login credentials with the first user; and
   storing, by the software service provider, the login credentials in the one or more data storage devices;
receiving an authentication request to access the first user account, wherein:
   the authentication request is received via a first HTTP/HTTPS request, the first HTTP/HTTPS request including the login credentials;
authenticating the authentication request, wherein the authenticating comprises:
   verifying the login credentials;
in response to the authenticating, allowing access to the first user account;
requesting/ascertaining a first location corresponding to a current user location of the user device using an asynchronous or synchronous method or function;
updating a last known location of the user using the first location;
displaying a set of one or more elements based on the first location,
   wherein each of the set of one or more elements comprises a group corresponding to a particular place or event, and wherein each of the set of one or more elements is associated with a particular location;
wherein the set of one or more elements are selected from a stored set based on the first location by determining respective particular locations associated with one or more elements in the stored set are within a particular distance from the first location;
wherein determining respective particular locations associated with one or more elements in the stored set are within a particular distance from the first location comprises:
   executing a query using the first location, the fine query comprising applying a spatial convenience function;
providing results to the mobile or web application;
displaying the results on the user device using the mobile or web application;
wherein each of the set of one or more elements is a selectable element linking to a respective group and/or group page/view;
wherein each respective group and/or group page/view comprises a message board, chat room, and/or pages/views allowing one or more group members to interact and/or share information;
wherein each group and/or group page/view displays a list of group members comprising icons, graphical elements, and/or textual elements;
wherein each of the list of group members is a selectable element linking to a respective group member profile;
   wherein each profile comprises:
      a direct message link; and/or
      one or more social media profile links.

### Embodiment 11

A system configured to perform the above method of Embodiment 10.

### Embodiment 12

One or more computer readable media storing instructions to execute the above method of Embodiment 10.

### Embodiment 13

A method comprising:
providing a mobile or web application to a first user, wherein the first user is using a first mobile device;
determining a first location of the first mobile device;
based on the first location, identifying a first set of groups comprising one or more groups each associated with one or more respective group locations within a predefined distance from the first location, wherein the first set of groups comprises at least a first group associated with a first group location within the predefined distance from the first location;
allowing the first user to discover, view, join, and/or access the first group via one or more first group pages and/or views without permission, approval, and/or manual approval, from other group members, group moderators, and/or group administrators;
providing the mobile or web application to a second user, wherein the second user is using a second mobile device;
determining a second location of the second mobile device;
based on the second location, identifying a second set of groups comprising one or more groups each associated with one or more respective group locations within the predefined distance from the second location, wherein the second set of groups comprises at least the first group associated with the first group location within the predefined distance from the second location;
allowing the second user to discover, view, join, and/or access the first group via the one or more first group pages and/or views without permission, approval, and/or manual approval, from the other group members, group moderators, and/or group administrators;
providing the mobile or web application to a third user, wherein the third user is using a third mobile device;
determining a third location of the third mobile device;
based on the third location, identifying a third set of groups comprising one or more groups each associated with one or more respective group locations within the predefined distance from the third location, wherein the third set of groups comprises at least the first group associated with the first group location within the predefined distance from the third location;
allowing the third user to discover, view, join, and/or access the first group via the one or more first group pages and/or views without permission, approval, and/or manual approval, from the other group members, group moderators, and/or group administrators;
allowing the first user to share first content comprising a first image or video with the first group without tagging the first group and/or without searching or entering information associated with the first group and/or without permission, approval, and/or manual approval, from the other group members, group moderators, and/or group administrators;
allowing the second user to share second content comprising a second image or video with the first group without tagging the first group and/or without searching or entering information associated with the first group and/or without permission, approval, and/or manual approval, from the other group members, group moderators, and/or group administrators;
allowing the third user to share third content comprising a third image or video with the first group without tagging the first group and/or without searching or entering information associated with the first group and/or without permission, approval, and/or manual approval, from the other group members, group moderators, and/or group administrators;
allowing only group members access to the first content, second content, and third content;
wherein the access to the first content, second content, and third content comprises presenting and/or allowing selection of a GUI element to initiative and/or begin a automatic succession and/or sequential display of the first content, second content, and third content;
wherein the automatic succession and/or sequential display comprises automatically identifying a first order displaying the first content, second content, and third content in the first order;
wherein the first order comprises a reverse chronological order or a chronological order;
wherein one or more of the first content, second content, and third content are each displayed for corresponding first, second, and third limited durations and/or a predefined durations;
wherein each of the corresponding first, second, and third limited durations and/or a predefined durations are equal to each other, or not equal to each other;
wherein the corresponding first, second, and third limited durations and/or a predefined durations are determined based on each of a corresponding first content-type, second content-type, and/or third content type;
wherein each of the corresponding first content-type, second content-type, and/or third content type are identical or different;
wherein each of the corresponding first content-type, second content-type, and/or third content type comprise an image file type or video file type.

### Embodiment 14

A system configured to perform the above method of Embodiment 13.

### Embodiment 15

One or more computer readable media storing instructions to execute the above method of Embodiment 13.

### Embodiment 16

A method comprising:
storing a first set of data comprising:
   a first set of groups;
   a first set of group locations corresponding to each group of the first set of groups, wherein each of the first set of group locations comprises a group latitude and/or group longitude;
   a first set of group location strings corresponding to each group of the first set of groups, wherein each group location string of the first set of group location strings encodes a group region which includes and/or surrounds each group location of the first set of group locations;
determining, identifying, and/or receiving a first device location associated with a first device associated with a first user, wherein the first device location comprises a device latitude and/or device longitude;
calculating, identifying, and/or determining a first device location string, wherein the first device location string encodes a device region which includes and/or surrounds the first device location;
identifying, selecting, filtering, referencing, and/or retrieving, from the first set of data, a first group location string partially and/or fully matching the first device location string, wherein the first group location string corresponds to a first group region;
identifying, selecting, filtering, referencing, and/or retrieving, from the first set of data, a first subset of groups corresponding to the first group location string;
calculating, identifying, and/or determining a first subset of group location strings corresponding to a first subset of group regions neighboring the first group region;
identifying, selecting, filtering, referencing, and/or retrieving, from the first set of data, a second subset of groups corresponding to the first subset of group location strings;
identifying, selecting, filtering, referencing, and/or retrieving, from the first subset of groups and/or the second subset of groups, a third subset of groups;
wherein, the identifying, selecting, filtering, referencing, and/or retrieving, from the first subset of groups and/or the second subset of groups, the third subset of groups comprises:
   identifying, selecting, filtering, referencing, and/or retrieving, from the first set of data, a first subset of group locations corresponding to the first subset of groups and/or a second subset of group locations corresponding to the second subset of groups;
   calculating, identifying, and/or determining a first set of distances between the first device location and each of the first subset of group locations and/or each of the second subset of group locations;
   calculating, identifying, comparing, filtering, and/or determining a first subset of the first set of distances comprising only distances of the first set of distances that are within, less than, and/or less than, or equal to, a first predefined distance and/or radius;
   identifying, selecting, filtering, referencing, and/or retrieving, from the first set of data, group data associated with the third subset of groups, wherein the third subset of groups correspond to groups corresponding to the first subset of the first distances;
displaying a first list, set, and/or subset of group display elements corresponding to the group data.

### Embodiment 17

A system configured to perform the above method of Embodiment 16.

### Embodiment 18

One or more computer readable media storing instructions to execute the above method of Embodiment 16.

### Embodiment 19

A system comprising:
one or more storage devices comprising one or more databases, data stores, memory components, computer readable media, and/or non-transitory computer readable media;
one or more processors in communication with the one or more storage devices;
one or more servers; and/or
one or more load balancers;
   the system configured for:
storing, in the one or more storage devices, a first set of data comprising:
   a first set of groups;
   a first set of group locations corresponding to each group of the first set of groups, wherein each of the first set of group locations comprises a group latitude and/or group longitude;
   a first set of group location strings corresponding to each group of the first set of groups, wherein each group location string of the first set of group location strings encodes a group region which includes and/or surrounds each group location of the first set of group locations;
determining, identifying, and/or receiving a first device location associated with a first device associated with a first user, wherein the first device location comprises a device latitude and/or device longitude;
calculating, identifying, and/or determining a first device location string, wherein the first device location string encodes a device region which includes and/or surrounds the first device location;
identifying, selecting, filtering, referencing, and/or retrieving, from the first set of data, a first group location string partially and/or fully matching the first device location string, wherein the first group location string corresponds to a first group region;
identifying, selecting, filtering, referencing, and/or retrieving, from the first set of data, a first subset of groups corresponding to the first group location string;
calculating, identifying, and/or determining a first subset of group location strings corresponding to a first subset of group regions neighboring the first group region;
identifying, selecting, filtering, referencing, and/or retrieving, from the first set of data, a second subset of groups corresponding to the first subset of group location strings;
identifying, selecting, filtering, referencing, and/or retrieving, from the first subset of groups and/or the second subset of groups, a third subset of groups;
wherein, the identifying, selecting, filtering, referencing, and/or retrieving, from the first subset of groups and/or the second subset of groups, the third subset of groups comprises:
   identifying, selecting, filtering, referencing, and/or retrieving, from the first set of data, a first subset of group locations corresponding to the first subset of groups and/or a second subset of group locations corresponding to the second subset of groups;
   calculating, identifying, and/or determining a first set of distances between the first device location and each of the first subset of group locations and/or each of the second subset of group locations;
   calculating, identifying, comparing, filtering, and/or determining a first subset of the first set of distances comprising only distances of the first set of distances that are within, less than, and/or less than, or equal to, a first predefined distance and/or radius;
   identifying, selecting, filtering, referencing, and/or retrieving, from the first set of data, group data associated with the third subset of groups, wherein the third subset of groups correspond to groups corresponding to the first subset of the first distances;
displaying a first list, set, and/or subset of group display elements corresponding to the group data.

### Embodiment 20

A method to execute the operations of the above system of Embodiment 19.

### Embodiment 21

One or more computer readable media storing instructions to execute the operations of the above system of Embodiment 19.

### Embodiment 22

A system comprising:
one or more storage devices comprising one or more databases, data stores, memory components, computer readable media, and/or non-transitory computer readable media;
one or more processors in communication with the one or more storage devices;
one or more servers; and/or
one or more load balancers;
   the system configured for:
allowing a first set users to asynchronously newly discover a first group associated with a first group location by asynchronously displaying the first group when each of the first set of users, and/or a first set of devices corresponding to each of the first set of users, is determined to be within a predefined distance of the first group location
allowing the first set users to asynchronously join the first group without an invitation from a current member of the first group;
allowing the first set users to asynchronously share a first set of content items to, or with, the first group, where each content item of the first set of content items comprises an image or video;
storing each content item of the first set of content items in association with the first group, a first group identifier, and/or a date and/or time corresponding to a time of sharing;
allowing display of the first set of content to only current group members of the first group;
receiving a first request from a first current group member to view the first set of content;
in response to receiving the first request, initiating the display the first set of content, wherein initiating the display the first set of content comprises:
   identifying, searching for, sorting, and/or retrieving each content item of the first set of content items by referencing the first group identifier;
      wherein the identifying, searching for, sorting, and/or retrieving each content item of the first set of content items is carried out at least partially by a parallel process;
   beginning a sequential and/or automatic display of each content item of the first set of content items for a particular duration and/or in a particular order, wherein the particular order comprises a chronological order or reverse-chronological order with respect to the time of sharing.

### Embodiment 23

A method to execute the operations of the above system of Embodiment 22.

### Embodiment 24

One or more computer readable media storing instructions to execute the operations of the above system of Embodiment 22.

### Embodiment 25

A system comprising:
one or more storage devices comprising one or more databases, data stores, memory components, computer readable media, and/or non-transitory computer readable media;
one or more processors in communication with the one or more storage devices;
one or more servers; and/or one or more load balancers;
   the system configured for:
storing a first set of groups data:
   wherein the first set of groups data comprises a first set of group identifiers and corresponding group locations;
   wherein each of the corresponding group locations comprises a latitude and longitude;
wherein the first set of groups data comprises a first group identifier and a corresponding first group location;
wherein the first set of groups data comprises a second group identifier and a corresponding second group location;
wherein the first set of groups data comprises a third group identifier and a corresponding third group location;
determining and/or detecting a first user location based on a first location associated with a first user and/or a first user device;
determining and/or detecting a second user location based on a second location associated with a second user and/or a second user device;
presenting a first subset of the first set of groups data to the first user;
wherein the first subset of groups data includes, from the first set of groups data, some or all group identifiers corresponding to group locations that do not exceed a predefined distance from the first user location;
wherein the first subset of groups data does not include and/or excludes, from the first set of groups data, some or all group identifiers corresponding to group locations that exceed the predefined distance from the first user location;
asynchronous to the presenting the first subset, presenting a second subset of the first set of groups data to the second user;
wherein the second subset of groups data includes, from the first set of groups data, some or all group identifiers corresponding to group locations that do not exceed the predefined distance from the second user location;
wherein the second subset of groups data does not include and/or excludes, from the first set of groups data, some or all group identifiers corresponding to group locations that exceed the predefined distance from the second user location.

### Embodiment 26

The system of Embodiment 25, the system further configured for:
wherein the first subset includes the first group identifier and the second group identifier;
wherein the first subset does not include and/or excludes the third group identifier;
wherein the second subset does not include and/or excludes the first group identifier;
wherein the second subset includes the second group identifier and third group identifier;
wherein the first user location and the second user location do not exceed a first distance from each other, the first distance comprising twice the predefined distance.

### Embodiment 27

The system of Embodiment 25, the system further configured for:
wherein the first subset does not include and/or excludes some or all group identifiers included in the second subset;
wherein the second subset does not include and/or excludes some or all group identifiers included in the first subset;
wherein the distance between the first user location and the second user location exceeds a first value comprising twice the predefined distance and/or a second value comprising any value greater than twice the predefined distance.

### Embodiment 28

The system of Embodiment 25, the system further configured for:
determining that the first user location does not exceed the predefined distance from the first group location using a first process comprising:
   determining, identifying, and/or calculating a first distance between the first user location and the first group location;
   wherein the determining, identifying, and/or calculating the first distance between the first user location and the first group location comprises:
      querying, requesting, identifying, and/or retrieving the first user location, wherein the first user location comprises a first user latitude and a first user longitude;
      querying, requesting, identifying, and/or retrieving the first group location, wherein the first group location comprises a first group latitude and a first group longitude;
      entering, inputting, and/or delivering the first user latitude, the first user longitude, the first group latitude, and/or the first group longitude into a function comprising a spatial convenience function to determine a first minimum spherical distance between the first user location and the first group location;
      comparing a first result of the spatial convenience function with the predefined distance;
in response to determining that the first user location does not exceed the predefined distance from the corresponding first group location, including the first group identifier in the first subset;
determining that the first user location exceeds the predefined distance from the second group location using the first process and/or a second process comprising:
   determining, identifying, and/or calculating a second distance between the first user location and the second group location;
   wherein the determining, identifying, and/or calculating the second distance between the first user location and the second group location comprises:
      querying, requesting, identifying, and/or retrieving the first user location, wherein the first user location comprises the first user latitude and the first user longitude;
      querying, requesting, identifying, and/or retrieving the second group location, wherein the second group location comprises a second group latitude and a second group longitude;
      entering, inputting, and/or delivering the first user latitude, the first user longitude, the second group latitude, and/or the second group longitude into the function comprising the spatial convenience function to determine a second minimum spherical distance between the first user location and the second group location;
      comparing a second result of the spatial convenience function with the predefined distance;
in response to determining that the first user location exceeds the predefined distance from the second group location, not including and/or excluding the second group identifier from the first subset.

### Embodiment 29

The system of Embodiment 28, the system further configured for:
in response to determining that the second user location does not exceed the predefined distance from the second group location, including the second group identifier in the second subset;
in response to determining that the second user location exceeds the predefined distance from the first group location, not including and/or excluding the first group identifier from the second subset.

### Embodiment 30

The system of Embodiment 28, the system further configured for:
in response to determining that the second user location does not exceed the predefined distance from the first group location, including the first group identifier in the second subset;
in response to determining that the second user location does not exceed the predefined distance from the second group location, including the second group identifier in the second subset.

### Embodiment 31

The system of Embodiment 28, the system further configured for:
in response to determining that the first user location does not exceed the predefined distance from the first group location, including the first group identifier in the first subset;
in response to determining that the first user location exceeds the predefined distance from the second group location, not including and/or excluding the second group identifier from the first subset;
in response to determining that the first user location does not exceed the predefined distance from the third group location, including the third group identifier in the first subset;
in response to determining that the second user location does not exceed the predefined distance from the second group location, including the second group identifier in the second subset;
in response to determining that the second user location exceeds the predefined distance from the first group location, not including and/or excluding the first group identifier from the second subset;
in response to determining that the second user location does not exceed the predefined distance from the third group location, including the third group identifier in the second subset.

### Embodiment 32

A method to execute the operations of any of the above systems of Embodiments 25-31.

### Embodiment 33

One or more computer readable media storing instructions to execute the operations of any of the above systems of Embodiments 25-31.

### Embodiment 34

A system comprising:
one or more storage devices comprising one or more databases, data stores, memory components, computer readable media, and/or non-transitory computer readable media;
one or more processors in communication with the one or more storage devices;
one or more servers; and/or
one or more load balancers;
   the system configured for:
allowing, permitting, and/or facilitating the first user to newly discover a first group based on a first user location of a first device associated with the first user and a first group location associated with the first group being within a first distance and/or a first predefined distance;
allowing, permitting, and/or facilitating a second user to newly discover the first group based on a second user location of a second device associated with the second user and the first group location associated with the first group being within a second distance and/or a second predefined distance;
allowing, permitting, and/or facilitating a third user to newly discover the first group based on a third user location of a third device associated with the third user and the first group location associated with the first group being within a third distance and/or a third predefined distance;
wherein one or more of the first distance and/or a first predefined distance, the second distance and/or a second predefined distance, and/or the third distance and/or a third predefined distance are equal;
identifying a first set of group members of a first group, wherein the first set of group members comprises a first group member, a second group member, and a third group member;
receiving and/or storing a first content item shared by the first group member connected with the first group;
receiving and/or storing a second content item shared by the second group member connected with the first group;
receiving and/or storing a third content item shared by the third group member connected with the first group.

### Embodiment 35

A system comprising:
one or more storage devices comprising one or more databases, data stores, memory components, computer readable media, and/or non-transitory computer readable media;
one or more processors in communication with the one or more storage devices;
one or more servers; and/or
one or more load balancers;
   the system configured for:
enabling discovery of a first set of groups by a first set of users and/or enabling discovery of the first set of groups only by the first set of users;
   wherein the first set of users comprises users within a first set of geographical regions;
allowing the first set of users to join the first set of groups;
allowing the first set of users to contribute to a first crowdsourced content section comprising first crowdsourced content of the first set of groups;
   wherein first crowdsourced content comprises a first set of images, videos, and/or stories contributed by a first set of group members of the first set of group;
   wherein allowing the first set of users to contribute to the first crowdsourced content section of the first set of groups comprises allowing the first set of users to upload content comprising a first set of images and/or videos;
allowing members of the first group access to the first crowdsourced content section;
   wherein allowing members of the first group access to the first crowdsourced content section comprises automatically sequentially displaying the first crowdsourced content, the first crowdsourced content comprising the first user content.

### Embodiment 36

A method to execute the operations of the above system of Embodiment 35.

### Embodiment 37

One or more computer readable media storing instructions to execute the operations of the above system of Embodiment 35.

### Embodiment 38

A system comprising:
one or more storage devices comprising one or more databases, data stores, memory components, computer readable media, and/or non-transitory computer readable media;
one or more processors in communication with the one or more storage devices;
one or more servers; and/or
one or more load balancers;
   the system configured for:
storing first group data associated with a first group in the one or more storage devices, the first group data comprising:
   a first group name;
   a first group location;
   a first unique group identifier;
storing second group data associated with a second group in the one or more storage devices, the second group data comprising:
   a second group name;
   a second group location;
   a second unique group identifier;
storing third group data associated with a third group in the one or more storage devices, the third group data comprising:
   a third group name;
   a third group location;
   a third unique group identifier;
determining a first group correspondence that the first group corresponds to at least one of:
   a first physical establishment at the first group location, wherein the first group location is within a predefined distance of a first user current location and/or a first user current device location; and/or
   a first event occurring at the first group location, wherein the first group location is within the predefined distance of the first user current location and/or the first user current device location;
in response to determining the first group correspondence, allowing a first user to join the first group;
determining the first user has joined the first group;
in response to determining the first user has joined the first group, adding the first user to a set of first group members;
determining a second group correspondence that the second group corresponds to at least one of:
   a second physical establishment at the second group location, wherein the second group location is within the predefined distance of the first user current location and/or the first user current device location; and/or
a second event occurring at the second group location, wherein the second group location is within the predefined distance of the first user current location and/or the first user current device location;
in response to determining the second group correspondence, allowing the first user to join the second group;
in response to determining the first user has joined the second group, adding the first user to a set of second group members;
determining a third group correspondence that the third group corresponds to at least one of:
   a third physical establishment at the third group location, wherein the third group location is within the predefined distance of the first user current location and/or the first user current device location; and/or
a third event occurring at the third group location, wherein the third group location is within the predefined distance of the first user current location and/or the first user current device location;
in response to determining the third group correspondence, allowing the first user to join the third group;
in response to determining the first user has joined the third group, adding the first user to a set of third group members;
in response to determining that the set of first group members comprises the first user, allowing the first user to create and/or upload a first solo-author story targeting and/or directed to the first group;
determining that the first solo-author story targeting and/or directed to the first group has been created and/or uploaded;
based on the determining that the first solo-author story targeting and/or directed to the first group has been created and/or uploaded, automatically classifying, associating, and/or connecting the first solo-author story and the first group and/or the first group location, and/or automatically contextualizing and/or hyper-contextualizing the first solo-author story in the first group and/or at first group location, wherein the first solo-author story inherits an association with the first group location;
wherein a context comprising an association with the first group location is automatically propagated and/or inherited by the first solo-author story;
storing the first solo-author story in a first story container, and storing the first solo-author story and/or first story container in association with the first group data and in association with the first unique group identifier;
in response to determining that the set of second group members comprises the first user, allowing the first user to create and/or upload a second solo-author story targeting and/or directed to the second group;
determining that the second solo-author story targeting and/or directed to the second group has been created and/or uploaded;
based on the determining that the second solo-author story targeting and/or directed to the second group has been created and/or uploaded, automatically classifying, associating, and/or connecting the second solo-author story and the second group and/or the second group location, and/or automatically contextualizing and/or hyper-contextualizing the second solo-author story in the second group and/or at second group location, wherein the second solo-author story inherits an association with the second group location;
wherein a context comprising an association with the second group location is automatically propagated and/or inherited by the second solo-author story;
storing the second solo-author story in a second story container, and storing the second solo-author story and/or second story container in association with the second group data and in association with the second unique group identifier;
in response to determining that the set of third group members comprises the first user, allowing the first user to create and/or upload a third solo-author story targeting and/or directed to the third group;
determining that the third solo-author story targeting and/or directed to the third group has been created and/or uploaded;
based on the determining that the third solo-author story targeting and/or directed to the third group has been created and/or uploaded, automatically classifying, associating, and/or connecting the third solo-author story and the third group and/or the third group location, and/or automatically contextualizing and/or hyper-contextualizing the third solo-author story in the third group and/or at third group location, wherein the third solo-author story inherits an association with the third group location;
wherein a context comprising an association with the third group location is automatically propagated and/or inherited by the third solo-author story;
storing the third solo-author story in a third story container, and storing the third solo-author story and/or third story container in association with the third group data and in association with the third unique group identifier;
determining a fourth group correspondence that the second group corresponds to at least one of:
   the second physical establishment at the second group location, wherein the second group location is within the predefined distance of a second user current location and/or a second user current device location; and/or
   the second event occurring at the second group location, wherein the second group location is within the predefined distance of the second user current location and/or the second user current device location;
in response to determining the fourth group correspondence, allowing a second user to join the second group;
determining the second user has joined the second group;
in response to determining the second user has joined the second group, adding the second user to a set of second group members;
in response to determining that the set of second group members comprises the second user, allowing the second user to create and/or upload a fourth solo-author story targeting and/or directed to the second group;
determining that the fourth solo-author story targeting and/or directed to the second group has been created and/or uploaded;
based on the determining that the fourth solo-author story targeting and/or directed to the second group has been created and/or uploaded, automatically classifying, associating, and/or connecting the fourth solo-author story and the second group and/or the second group location, and/or automatically contextualizing and/or hyper-contextualizing the fourth solo-author story in the second group and/or at second group location, wherein the fourth solo-author story inherits an association with the second group location;
wherein a context comprising an association with the second group location is automatically propagated and/or inherited by the fourth solo-author story;
storing the fourth solo-author story in a fourth story container, and storing the fourth solo-author story and/or fourth story container in association with the second group data and in association with the second unique group identifier;
determining a fifth group correspondence that the third group corresponds to at least one of:
   the third physical establishment at the third group location, wherein the third group location is within the predefined distance of a third user current location and/or a third user current device location; and/or
   the third event occurring at the third group location, wherein the third group location is within the predefined distance of the third user current location and/or the third user current device location;
in response to determining the fifth group correspondence, allowing a third user to join the third group;
determining the third user has joined the third group;
in response to determining the third user has joined the third group, adding the third user to a set of third group members;
in response to determining that the set of third group members comprises the third user, allowing the third user to create and/or upload a fifth solo-author story targeting and/or directed to the third group;
determining that the fifth solo-author story targeting and/or directed to the third group has been created and/or uploaded;
based on the determining that the fifth solo-author story targeting and/or directed to the third group has been created and/or uploaded, automatically classifying, associating, and/or connecting the fifth solo-author story and the third group and/or the third group location, and/or automatically contextualizing and/or hyper-contextualizing the fifth solo-author story in the third group and/or at second group location, wherein the fifth solo-author story inherits an association with the third group location;
wherein a context comprising an association with the third group location is automatically propagated and/or inherited by the fifth solo-author story;
storing the fifth solo-author story in a fifth story container, and storing the fifth solo-author story and/or fifth story container in association with the third group data and in association with the third unique group identifier;
detecting and/or identifying a first stories collection request by a first member of the set of first group members from a page and/or view associated with the first group;
in response to the first stories collection request, querying and/or retrieving a first collection of stories comprising the first story using the first unique group identifier;
wherein the first collection of stories includes stories associated with the first unique group identifier and/or excludes stories that are not associated with the first unique group identifier;
ephemerally displaying and/or presenting the first stories collection to the first member of the set of first group members;
wherein ephemerally displaying and/or presenting the first stories collection to the first member of the set of first group members comprises:
   sequentially and/or automatically displaying each subsequent story of the first stories collection in a first order after displaying an initial story of the first stories collection; and/or
   preloading a set of subsequent stories while the initial story of the first stories collection is displayed;
   preloading a subset of the set of subsequent stories while a subsequent story of the first stories collection is displayed;
detecting and/or identifying a second stories collection request by a first member of the set of second group members from a page and/or view associated with the second group;
in response to the second stories collection request, querying and/or retrieving a second collection of stories comprising the first story and the second story using the first unique group identifier;
wherein the second collection of stories includes stories associated with the second unique group identifier and/or excludes stories that are not associated with the second unique group identifier;
ephemerally displaying and/or presenting the second stories collection to the first member of the set of second group members;
wherein ephemerally displaying and/or presenting the second stories collection to the first member of the set of second group members comprises:
   sequentially and/or automatically displaying each subsequent story of the second stories collection in a second order after displaying an initial story of the second stories collection; and/or
   preloading a set of subsequent stories while the initial story of the second stories collection is displayed;
   preloading a subset of the set of subsequent stories while a subsequent story of the second stories collection is displayed;
detecting and/or identifying a third stories collection request by a first member of the set of third group members from a page and/or view associated with the third group;
in response to the third stories collection request, querying and/or retrieving a third collection of stories comprising the first story, the second story, and the third story using the first unique group identifier;
wherein the third collection of stories includes stories associated with the third unique group identifier and/or excludes stories that are not associated with the third unique group identifier;
ephemerally displaying and/or presenting the third stories collection to the first member of the set of third group members;
wherein ephemerally displaying and/or presenting the third stories collection to the first member of the set of third group members comprises:
   sequentially and/or automatically displaying each subsequent story of the third stories collection in a third order after displaying an initial story of the third stories collection; and/or
   preloading a set of subsequent stories while the initial story of the third stories collection is displayed;
   preloading a subset of the set of subsequent stories while a subsequent story of the third stories collection is displayed;
wherein the first user and the second user are not connections, followers, family, and/or friends;
wherein the first user and the third user are not connections, followers, family, and/or friends;
wherein the second user and the third user are not connections, followers, family, and/or friends;
   It will be understood, for example, that other embodiments may include more, or many more, than three groups and/or that other embodiments may include more, or many more, than five stories (by solo authors and/or by shared authors).

### Embodiment 39

A method to execute the operations of the above system of Embodiment 38.

### Embodiment 40

One or more computer readable media storing instructions to execute the operations of the above system of Embodiment 38.

### Embodiment 41

A system comprising:
one or more storage devices comprising one or more databases, data stores, memory components, computer readable media, and/or non-transitory computer readable media;
one or more processors in communication with the one or more storage devices;
one or more servers; and/or one or more load balancers;
   the system configured for:
storing first group data for a first group in the one or more storage devices, the first group data comprising:
   a first group name;
   a first group location;
   a first unique group identifier;
providing, to a first user, a first group page and/or view comprising at least some of the the first group data;
only allowing the first user to target a first story to the first group when the first user is within a predefined distance from the first group location;
storing the first story in association with the first unique group identifier; and
allowing discovery of the first story based on the first group location.

### Embodiment 42

A method to execute the operations of the above system of Embodiment 41.

### Embodiment 43

One or more computer readable media storing instructions to execute the operations of the above system of Embodiment 41.

### Embodiment 44

A system comprising:
one or more storage devices comprising one or more databases, data stores, memory components, computer readable media, and/or non-transitory computer readable media;
one or more processors in communication with the one or more storage devices;
one or more servers; and/or
one or more load balancers;
   the system configured for:
storing first group data for a first group in the one or more storage devices, the first group data comprising:
   a first group name;
   a first group location;
   a first unique group identifier;
providing, to a first user, a first group page and/or view comprising at least some of the first group data;
allowing the first user to contextualize a first story in the first group;
storing the first story in association with the first unique group identifier; and
allowing discovery of the first story based on the first group location.

### Embodiment 45

A method to execute the operations of the above system of Embodiment 44.

### Embodiment 46

One or more computer readable media storing instructions to execute the operations of the above system of Embodiment 44.

It will be understood that any of the given elements, steps, etc. in any of the given embodiments may be optional, recombinable, rearrangeable, and/or reorderable, and provided for example embodiment purposes only.

It will be further understood that a “set” may comprise one or more elements. For example, a “first set of groups” means “one or more groups.”

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed on a system of one or more computers in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on one or more computers having, or configured to communicate with, a display device, e.g., a LCD (liquid crystal display) or organic light-emitting diode (OLED) monitor, a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” or “configured for” in connection with systems, apparatus, and computer program components. That a system of one or more computers is configured to (or configured for) perform particular operations or actions means that the system has installed on it software, firmware, hardware, or a combination of them that in operation cause the system to perform the operations or actions. That one or more computer programs is configured to (or configured for) perform particular operations or actions means that the one or more programs include instructions that, when executed by data processing apparatus, cause the apparatus to perform the operations or actions. That special-purpose logic circuitry is configured to (or configured for) perform particular operations or actions means that the circuitry has electronic logic that performs the operations or actions.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

What is claimed is:

1: A system comprising:
one or more storage devices comprising one or more databases, data stores, memory components, computer readable media, and/or non-transitory computer readable media;
one or more processors in communication with the one or more storage devices;
the system configured for:
storing first group data in the one or more storage devices, the first group data comprising:
a first group name;
a first unique group identifier;
allowing a first user to join the first group.

2: The system of claim 1, further configured for:
determining the first user has joined the first group.

3: The system of claim 2, further configured for:
in response to determining the first user has joined the first group, adding the first user to a set of first group members.

4: The system of claim 3, further configured for:
in response to determining that the set of first group members comprises the first user, allowing the first user to upload a first story to the first group.

5: The system of claim 4, further configured for:
storing the first story in association with the first group data and in association with the first unique group identifier.

6: The system of claim 5, further configured for:
storing second group data in the one or more storage devices, the second group data comprising:
a second group name;
a second unique group identifier.

7: The system of claim 6, further configured for:
determining the first user has joined the second group;
in response to determining the first user has joined the second group, adding the first user to a set of second group members.

8: A method comprising:
storing first group data in the one or more storage devices, the first group data comprising:
a first group name;
a first unique group identifier;
allowing a first user to join the first group.

9: The method of claim 8, further comprising:
determining the first user has joined the first group.

10: The method of claim 9, further comprising:
in response to determining the first user has joined the first group, adding the first user to a set of first group members.

11: The method of claim 10, further comprising:
in response to determining that the set of first group members comprises the first user, allowing the first user to upload a first story to the first group.

12: The method of claim 11, further comprising:
storing the first story in association with the first group data and in association with the first unique group identifier.

13: The method of claim 12, further comprising:
storing second group data in the one or more storage devices, the second group data comprising:
a second group name;
a second unique group identifier.

14: The method of claim 13, further comprising:
determining the first user has joined the second group;
in response to determining the first user has joined the second group, adding the first user to a set of second group members.

15: A computer program product comprising a computer readable storage medium having instructions encoded thereon that, when executed by a processor, cause the processor to:
store first group data in the one or more storage devices, the first group data comprising:
a first group name;
a first unique group identifier;
allow a first user to join the first group.

16: The computer program product of claim 15, wherein the instructions, when executed by the processor, further cause the processor to:
determine the first user has joined the first group.

17: The computer program product of claim 16, wherein the instructions, when executed by the processor, further cause the processor to:
in response to determining the first user has joined the first group, add the first user to a set of first group members.

18: The computer program product of claim 17, wherein the instructions, when executed by the processor, further cause the processor to:
in response to determining that the set of first group members comprises the first user, allow the first user to upload a first story to the first group.

19: The computer program product of claim 18, wherein the instructions, when executed by the processor, further cause the processor to:
store the first story in association with the first group data and in association with the first unique group identifier.

20: The computer program product of claim 19, wherein the instructions, when executed by the processor, further cause the processor to:
store second group data in the one or more storage devices, the second group data comprising:
a second group name;
a second unique group identifier;
determine the first user has joined the second group;
in response to determining the first user has joined the second group, add the first user to a set of second group members.
